(19) United States
(12) Patent Application Publication
(10) Pub. No.: US 2025/0141542 A1
(43) Pub. Date: May 1, 2025

(54) RF PHASE OPTICAL TIME DOMAIN REFLECTOMETER

(71) Applicant: Infinera Corp., San Jose, CA (US)

(72) Inventors: Pierre Mertz, Baltimore, MD (US); Siddharth Varughese, Wheaton, MD (US)

(21) Appl. No.: 18/932,070

(22) Filed: Oct. 30, 2024

Related U.S. Application Data
(60) Provisional application No. 63/546,463, filed on Oct. 30, 2023.

(51) Int. Cl. H04B 10/071; H04B 10/2519; H04B 10/2575; H04B 10/29; H04B 10/508; H04B 10/54

(52) U.S. Cl. CPC H04B 10/071; H04B 10/2519; H04B 10/2575; H04B 10/29; H04B 10/508; H04B 10/54

(57) ABSTRACT

A disclosed optical system comprises a repeater disposed between a first span and a second span of an optical cable and a node receiving an optical signal from the first span and transmitting a reflection to the first span. The node comprises a transmitter coupled to the first span to transmit the optical signal, transmit pulses having an RF modulated tone, and provide a local reflection; a receiver to receive the local reflection and the pulse reflection and passing a filtered spectrum; and a DSP to: determine a first RF phase of the local reflection and a second RF phase of the pulse reflection; determine a second RF phase; determine a first span seismic pressure based on the first RF phase and determine a second span seismic pressure based on the second RF phase.

### CROSS REFERENCE TO RELATED APPLICATIONS

This application claims the benefit of U.S. Provisional Patent Application No. 63/546,463, filed Oct. 30, 2023, which is hereby incorporated herein by reference in its entirety.

### BACKGROUND

Optical communication systems typically include a first node that outputs optical carriers to one or more second nodes. The first and second nodes are connected to each other by one or more segments of optical fiber. At the first node, optical signals, each having a corresponding wavelength, and each being modulated to carry a different data stream, are multiplexed onto the optical fiber. In such systems, a laser and a modulator may be provided to generate each optical signal. Additionally, optical communication systems may include high-speed circuitry and components to generate high-speed optical signals at a transmit end (e.g., first node) of the system. At a receive end (e.g., second node), corresponding high-speed circuitry may be provided to detect the incoming data and to forward or distribute such data to lower capacity nodes. In subsea optical communication systems, one or more optical amplifier, such as an in-line optical amplifier, may be positioned at specific geographic locations between the first node and the second node along the one or more segments of optical fiber.

From time to time, environmental disturbances may occur at one or more location between the first node and the second node and along the one or more segments of fiber; however, real-time seismic sensing is typically performed by land-based seismometers. If an earthquake (that is, an environmental disturbance) occurs in the ocean, the delay before sensing the earthquake waves by the land-based seismometers delays any possible warning of a tsunami that may be caused by the earthquake under the ocean. Therefore, it is desirable to measure seismic events using sensors in the ocean. A network of such sensors can also help verify seismologists' models. Moreover, rapidly identifying the location of these environmental disturbances is desired.

Real-time temperature sensors in the ocean can help climate scientists forecast seasonal and long-term variations, such as from climate patterns like El Niño and La Niña. However, current marine temperature sensors that use real time wireless communication are typically limited to surface temperature measurements. Thus, it is desirable to have a network of temperature sensors at the bottom of the ocean to improve the climate scientists' models.

Prior methods of identifying a location of environmental disturbances, such as providing a sensor network along the optical communication system, are costly, time consuming, and would require additional maintenance.

### SUMMARY OF THE INVENTION

Thus, a need exists to identify the location of environmental disturbances utilizing currently deployed subsea optical communication equipment having standard lasers in commercial transponders.

Other attempts at seismic sensing may include detecting a seismic event utilizing a coherent receiver coupled to a submarine cable that may sense the state of polarization (“SOP”) from a received data stream in an optical signal, and based on the sensed SOP, may detect the seismic event. However, the SOP results from signal propagation over the entire length of the submarine cable, and, therefore, localizing the seismic event may be difficult.

Better localization can be achieved using SOP (State of Polarization) sensitive Optical Time Domain Reflectometry (SOP-OTDR). It has been shown that monitoring the State of Polarization in SOP-OTDR can detect and localize earthquakes due to birefringence changes caused by the motion of the cable. Exemplary SOP-OTDR systems are described in U.S. Patent Publication 2022/0303014, filed Mar. 21, 2022, and entitled “STATE OF POLARIZATION SENSITIVE COHERENT OPTICAL TIME DOMAIN REFLECTOMETRY”, the entire content of which is hereby incorporated herein, in its entirety. However, it is also desirable to measure and localize pressure changes caused by, for instance, a tsunami generated by that earthquake.

Fiber acoustic sensing may be more sensitive to seismic variations than SOP measurements. However, the fiber acoustic sensing measurements are limited to the span before the first submarine in-line node, and require high power and specialized equipment, thus increasing costs.

Generally, the present disclosure is directed towards apparatuses and methods for measuring changes in RF phase by sending an RF modulated optical signal (e.g., an optical pulse having an RF amplitude modulation applied) having a wavelength that overlaps with the HLLB (High Loss Loop Back) FBG (Fiber Bragg grating) in the in-line nodes of a submarine cable. The stream of reflected pulses, one for each repeater, may be passed through a narrowband filter and analyzed by a phase detector of a transceiver module to measure the reflected RF phase of each reflected pulse of the stream of reflected pulses. By measuring changes in the reflected RF phase of the RF modulated optical signal between successive reflected pulses, or between the RF phase of a local pulse reflection and respective RF phases of each reflected RF pulse, to get a phase difference, environmental disturbances, such as tidal pressure and temperature changes, can be detected and measured. Comparing the phase differences for the pulse reflections caused by neighboring optical repeaters may localize the pressure and temperature changes to the fiber span between said neighboring optical repeaters.

Consistent with the present disclosure, a node is provided. The node may comprise an optical source, a modulator, a transmitter module, a receiver module, and a digital signal processor. The optical source is configured to provide an optical signal into a fiber optic cable having at least two optical repeaters forming a first fiber optic span and a second fiber optic span. The modulator receives the optical signal and is configured to encode data into the optical signal. The transmitter module has circuitry configured to receive data to be encoded into the optical signal. The circuitry includes at least one driver circuit supplying drive signals to the modulator to cause the modulator to encode data. The circuitry is also configured to cause the modulator to generate a plurality of pulses having a radio frequency modulated tone, into the optical signal. The receiver module is operable to receive reflections of the optical signal from optical repeaters in the fiber optic cable where the optical signal has the radio frequency modulated tone. The digital signal processor is operable to: determine a first RF phase of a first pulse reflection corresponding to a first pulse of the plurality of pulses at a first instance of time, the first RF phase being determined using the radio frequency modulated tone of the first pulse reflection; determine a second RF phase of a second pulse reflection corresponding to the first pulse and received at a second instance of time after the first instance of time, the second RF phase being determined using the radio frequency modulated tone of the second pulse reflection; and determine a first seismic pressure within the first fiber optic span based on the first RF phase and a second seismic pressure within the second fiber optic span based on the second RF phase.

Consistent with the present disclosure, a subsea optical communication system is disclosed. The subsea optical communication system comprises a fiber optic cable, an optical repeater, and a primary node. The optical repeater is coupled to the fiber optic cable. The optical repeater comprises a high loss loopback having a fiber Bragg grating having a tuned frequency. The high loss loopback is operable to generate a pulse reflection at the tuned frequency. The primary node is also coupled to the fiber optic cable. The fiber optic cable between the optical repeater and the primary node forms a first span. The primary node comprises an optical source, a modulator, a transmitter module, a receiver, an optical loopback, and a digital signal processor. The optical source is configured to provide an optical signal. The modulator receives the optical signal from the optical source. The modulator is configured to encode data into the optical signal. The transmitter module has circuitry configured to receive data to be encoded into the optical signal. The circuitry includes at least one driver circuit supplying drive signals to the modulator to cause the modulator to encode data. The circuitry is configured to cause the modulator to generate a plurality of pulses having a radio frequency modulated tone, into the optical signal. The receiver module is operable to receive reflections of the optical signal. The reflections of the optical signal have pulse reflections with the radio frequency modulated tone. The optical loopback is configured to generate a local reflection of the optical signal from the transmitter module and direct the local reflection towards the receiver module as a local pulse reflection. The local reflection has the radio frequency modulated tone. The digital signal processor operable to: determine a first RF phase of the local pulse reflection corresponding to a first pulse at a first instance of time, the first RF phase being determined using the radio frequency modulated tone of the local pulse reflection; determine a second RF phase of the pulse reflection corresponding to the first pulse and received at a second instance of time after the first instance of time, the second RF phase being determined using the radio frequency modulated tone of the pulse reflection; and determine an environmental parameter within the first fiber optic span based on a first difference between the first RF phase and the second RF phase.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

Implementations of the above techniques include methods, apparatus, systems, and computer program products are described. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1A is a block diagram showing an exemplary embodiment of an optical communication system constructed in accordance with the present disclosure;

FIG. 1B is a block diagram showing another exemplary embodiment of the optical communication system constructed in accordance with the present disclosure;

FIG. 2 is a block diagram showing an exemplary embodiment of a primary node transmitter constructed in accordance with the present disclosure;

FIG. 3 is a block diagram showing an exemplary embodiment of a primary node transmitter digital signal processor (DSP) constructed in accordance with the present disclosure;

FIG. 4 is an example of a spectral plot showing optical subcarriers and a pulse having an RF modulated tone constructed in accordance with the present disclosure;

FIG. 5A is a diagram of an exemplary embodiment of a location of a pulse and pulse reflection within the optical communication system of FIG. 1B at a first instance in time;

FIG. 5B is a diagram of an exemplary embodiment of a location of a pulse and pulse reflection within the optical communication system of FIG. 1B at a second instance in time;

FIG. 5C is a diagram of an exemplary embodiment of a location of a pulse and pulse reflection within the optical communication system of FIG. 1B at a third instance in time;

FIG. 6 is a diagram of an exemplary embodiment of a subsea optical communication system aspect of the optical communication system of FIG. 1 including one or more optical amplifier at a known geographic location;

FIG. 7 is a diagram showing an exemplary embodiment of a secondary node receiver constructed in accordance with the present disclosure;

FIG. 8 is a diagram showing an exemplary embodiment of a secondary node receiver DSP consistent with the present disclosure;

FIG. 9 is a flowchart of an exemplary embodiment of a detection process constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” “an example,” “one embodiment,” some embodiments,” or “an embodiment,” means that a particular element, feature, structure, or characteristic described in connection with the embodiment is included in at least one embodiment and may be used in conjunction with other embodiments. The appearance of the phrase “in some embodiments” or “one example” or “embodiments” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The use of the terms “upstream” and “downstream” are for explanatory purposes, however, it will be understood that the direction of travel of optical data may be reversed.

Circuitry, as used herein, may be analog and/or digital components, or one or more suitably programmed processors (e.g., microprocessors) and associated hardware and software, or hardwired logic. Also, “circuitry” may perform one or more functions. The term “circuitry,” may include hardware, such as a processor (e.g., microprocessor), an application specific integrated circuit (ASIC), a field programmable gate array (FPGA), a combination of hardware and software, and/or the like. The term “processor” as used herein means a single processor or multiple processors working independently or together to collectively perform a task.

Software may include one or more computer readable instructions that when executed by one or more components cause the component to perform a specified function. It should be understood that the algorithms described herein may be stored on one or more non-transitory computer readable medium. Exemplary non-transitory computer readable mediums may include random access memory, read only memory, flash memory, and/or the like. Such non-transitory computer readable mediums may be electrically based, optically based, magnetically based, and/or the like.

The methods and systems herein disclosed may be used in optical networks. In one embodiment, the optical network has one or more band, or portion of wavelength. As used herein, the C-Band is a band of light having a wavelength between 1528.6 nm and 1566.9 nm. The L-Band is a band of light having a wavelength between 1569.2 nm and 1609.6 nm. Because the wavelength of the C-Band is smaller than the wavelength of the L-Band, the wavelength of the C-Band may be described as a short, or a shorter, wavelength relative to the L-Band. Similarly, because the wavelength of the L-Band is larger than the wavelength of the C-Band, the wavelength of the L-Band may be described as a long, or a longer, wavelength relative to the C-Band.

The generation of laser beams for use as optical data carrier signals is explained, for example, in U.S. Pat. No. 8,155,531, entitled “Tunable Photonic Integrated Circuits”, issued Apr. 10, 2012, and U.S. Pat. No. 8,639,118, entitled “Wavelength division multiplexed optical communication system having variable channel spacings and different modulation formats,” issued Jan. 28, 2014, which are hereby fully incorporated in their entirety herein by reference.

A reconfigurable add-drop multiplexer (ROADM) node is an all-optical subsystem that enables remote configuration of wavelengths at any ROADM node. A ROADM is software-provisionable so that a network operator can choose whether a wavelength is added, dropped, or passed through the ROADM node. The technologies used within the ROADM node include wavelength blocking, planar lightwave circuit (PLC), and wavelength selective switching (WSS)—though the WSS has become the dominant technology. A ROADM system is a metro/regional WDM or long-haul DWDM system that includes a ROADM node. ROADMs are often talked about in terms of degrees of switching, ranging from a minimum of two degrees to as many as eight degrees, and occasionally more than eight degrees. A “degree” is another term for a switching direction and is generally associated with a transmission fiber pair. A two-degree ROADM node switches in two directions, typically called East and West. A four-degree ROADM node switches in four directions, typically called North, South, East, and West. In a WSS-based ROADM network, each degree requires an additional WSS switching element. So, as the directions switched at a ROADM node increase, the ROADM node's cost increases.

As used herein, a fiber optic span, or optical fiber link, is the spread or extent of a fiber optic cable between the fiber optic cables' terminals. Generally, a fiber optic span is an unbroken or uninterrupted segment of fiber optic cable between amplifiers. For instance, if a fiber optic cable carried a signal from point A through a repeater or amplifier at point B and on to point C, the fiber optic cable is said to have two fiber optic spans, a first fiber optic span from A to B, and a second fiber optic span from B to C, the length of the fiber optic spans being the distance between the respective points. A fiber optic span may also be the distance between amplifiers, even if the fiber optic cable has not been terminated. For example, the fiber optic cable may not be terminated at an optical in-line amplifier.

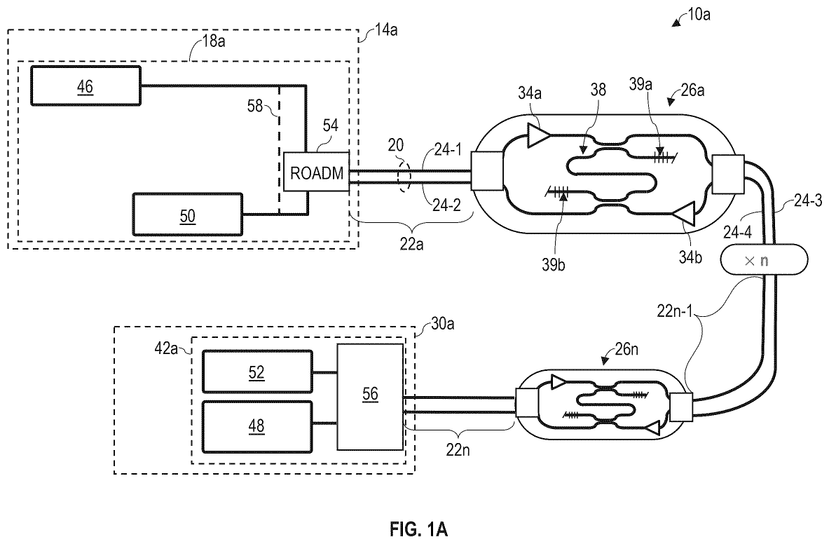

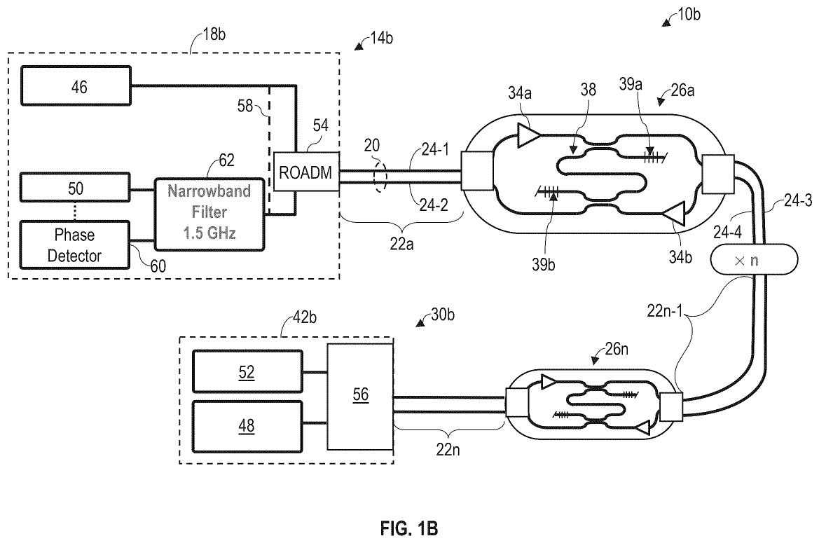

Referring now to the drawings, and in particular to FIG. 1A, shown therein is a diagram of an exemplary embodiment of a first optical communication system 10a constructed in accordance with the present disclosure configured to measure an environmental parameter, such as temperature and/or seismic pressure. The first optical communication system 10a may be a first aspect of an optical communication system 10 having a primary node 14 optically coupled to a secondary node 30 via an optical fiber submarine cable 20 and, optionally, having one or more optical repeater 26 disposed therebetween. A portion of the optical fiber submarine cable 20 between adjacent optical repeaters 26, or between a particular optical repeater 26 and one of the primary node 14 and the secondary node 30 may be comprise one or more fiber optic spans 24 (referred to collectively as fiber optic spans 24 or singularly as fiber optic span 24). Each fiber optic span 24 may have a particular length and/or distance, e.g., length of the optical fiber submarine cable 20.

As shown in FIG. 1A, the first optical communication system 10a includes, for example, a first primary node 14a. The first primary node 14a may be optically coupled with a first secondary node 30a via one or more fiber optic spans 24 (referred to collectively as fiber optic spans 24). One or more of, or portions of, the fiber optic spans 24 may be within, or make, an optical fiber submarine cable 20.

The first primary node 14a includes a first transceiver module 18a, for example, that supplies a downstream optical signal having a plurality of subcarriers and a test subcarrier with an optical tone (e.g., the test subcarrier may be a first subcarrier of the optical signal and an RF modulated tone 180 described in detail below) to a first fiber optic span 24-1, and receives an upstream signal having at least one reflection of the test subcarrier (described in detail below) from a second fiber optic span 24-2 of the fiber optic spans 24.

In one embodiment, the first optical communication system 10a includes one or more optical repeater 26a-n (referred to collectively as optical repeater 26) between the first primary node 14a and the first secondary node 30a. The optical repeater 26 may, in part, boost signals in the optical fiber submarine cable 20. The optical repeater 26 may be constructed as an “optical repeater” that receives, amplifies, and transmits the optical signals thereby increasing a transmission range of the optical signals. Not all optical communication systems 10 utilize optical repeaters 26a-n and the present disclosure may apply to both repeater and repeaterless systems. In one embodiment, the optical repeater 26 may be a repeater or an optical in-line amplifier.

The optical repeater 26 may be optically coupled with the primary node 14 via the first and second fiber optic spans 24-1, 24-2. The optical repeater 26 may be optically coupled with the secondary node 30 via a third fiber optic span 24-3 and a fourth fiber optic span 24-4 of the fiber optic spans 24.

In one embodiment, the optical repeater 26 may include one or more amplifiers 34 (such as a first amplifier 34a and a second amplifier 34b, which may be referred to simply as amplifiers 34) and a high loss loopback 38. As shown in FIGS. 1A-1B, one of the amplifiers 34 may be optically coupled to the first, second, third, and fourth fiber optic spans 24-1, 24-2, 24-3, and 24-4 to amplify the optical signal traveling in the downstream and upstream directions. For example, the first amplifier 34a may be operable to amplify the optical signal in the first fiber optic span 24-1 before the optical signal continues downstream to the third fiber optic span 24-3. Similarly, the second amplifier 34b of the optical repeater 26 may amplify an incoming optical signal in the fourth fiber optic span 24-4 before the incoming optical signal continues upstream to the second fiber optic span 24-2. In one embodiment, the one or more amplifiers 34 are erbium doped optical amplifiers.

In one embodiment, the high loss loopback 38 may be an optical coupler operable to be tuned to a particular frequency and having a fiber Bragg grating 39 to cause a portion of the optical signal at the tuned frequency (e.g., having the RF modulated tone 180) to be inserted into the incoming optical signal in the upstream direction (e.g., the reflection). The high loss loopback 38 may include two fiber Bragg gratings 39 identified as a first fiber Bragg grating 39a and a second fiber Bragg grating 39b. The first fiber Bragg grating 39a has a grating bandwidth and reflects a first portion of the optical signal corresponding to the grating bandwidth and amplified by the first amplifier 34a, to cause the first portion of the optical signal to be inserted onto the second fiber optic span 24-2. The second fiber Bragg grating 39b reflects a second portion of the incoming optical signal having the grating bandwidth and amplified by the second amplifier 34b, to cause the second portion of the incoming optical signal to be inserted onto the third fiber optic span 24-3.

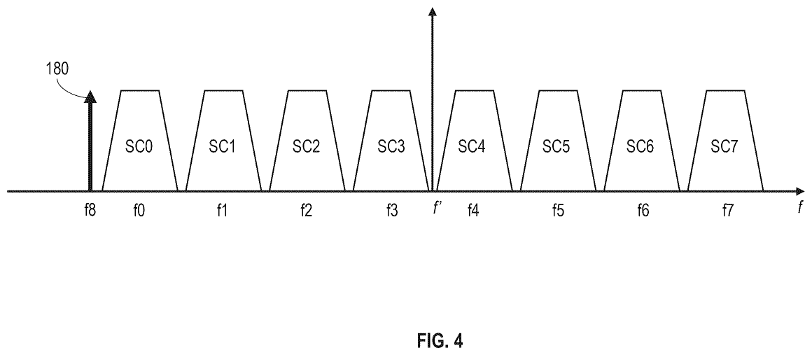

Each optical signal may include one or more optical subcarrier as described below in more detail and shown in FIG. 4. Collectively, a number of the optical subcarriers output from the secondary transceiver 42 of the secondary node 30 may be equal to, less than, or greater than the number of optical subcarriers output from the transceiver module 18 of the primary node 14.

In one embodiment, one or more of the first primary node 14a and the first secondary node 30a may include a coherent optical time domain reflectometer (COTDR) to perform cable monitoring tests having a high accuracy and traditionally utilized to find optical fiber faults, such as a severed cable.

The optical communication system 10 typically utilizes Wavelength Division Multiplexing (WDM) such as Dense Wavelength Division Multiplexing (DWDM). Dense Wavelength Division Multiplexing multiplexes multiple optical carrier signals onto a single optical fiber by using different laser light wavelengths.

In the first optical communication system 10a, one or more optical data carrier signals may be transmitted in one or more optical subcarrier (shown in FIG. 4 and discussed below) along with the tone subcarrier through the optical fiber submarine cable 20. In particular, selected subcarriers may be transmitted in the downstream direction from the first primary node 14a to the first secondary node 30a, and other subcarriers may be transmitted in the upstream direction from the first secondary node 30a to the first primary node 14a.

In some embodiments, the first optical communication system 10a may include one or more additional ones of the first primary node 14a and/or the first secondary node 30a and the optical fiber submarine cables 20, fewer of the first primary nodes 14a and/or the first secondary nodes 30a and the optical fiber submarine cables 20, or may have a configuration different from that described above. For example, the first optical communication system 10a may have a mesh configuration or a point-to-point configuration.

As shown in FIG. 1A, in one embodiment, the first transceiver module 18a may generally comprise one or more transmitter module 46 (hereinafter transmitter module 46) and one or more receiver module 50 (hereinafter receiver module 50) constructed as a coherent receiver and optically coupled to a ROADM 54. The first transceiver module 18a may further (optionally) include an optical loopback 58 operable to be tuned to a particular wavelength and cause a portion of the optical signal at the tuned wavelength (e.g., having the RF modulated tone 180 of FIG. 4) to be sent from the transmitter module 46 towards the receiver module 50 (e.g., as the reflection).

In one embodiment, the transmitter module 46 may include the test subcarrier (e.g., as the first subcarrier) into the optical signal at discrete intervals. In one embodiment, the transmitter module 46 may generate a pulse including the RF modulated tone 180 at one or more period of time. For example, the transmitter module 46 may cause generation of a first pulse at a first instance in time and a second pulse at a second instance in time, where each of the first pulse and the second pulse include the RF modulated tone 180 and provide each pulse into the optical signal. In one embodiment, each pulse may have a pulse width that is less than a propagation duration of the optical signal in the one or more fiber optic spans 24 of the optical fiber submarine cable 20, e.g., within a shortest one of the one or more fiber optic spans 24. In one embodiment, each pulse may have a duty cycle that is greater than twice a propagation duration of the optical signal across the optical fiber submarine cable 20 from the primary node 14 to the secondary node 30. In this way, the transmitter module 46 may ensure that the second pulse sent downstream in the optical signal does not cause a second reflection that may interfere with one or more first reflections from the first pulse.

In one embodiment, the first secondary node 30a is constructed similar to and may have a structure similar to and operate in a manner similar to that described above with respect to the first primary node 14a. In one example, however, the first secondary transceiver 42a may supply a modulated optical signal in the upstream direction. The first secondary transceiver 42a may comprise, for example, a receiver module 52 constructed as a coherent receiver and in accordance with the receiver module 50, a transmitter module 48 constructed in accordance with the transmitter module 46, and a ROADM 56 constructed in accordance with the ROADM 54.

Referring now to FIG. 1B, shown therein a block diagram of another exemplary embodiment of the optical communication system 10 constructed in accordance with the present disclosure. The optical communication system 10 is shown as a second optical communication system 10b and includes, for example, a second primary node 14b. The second primary node 14b may be optically coupled with a second secondary node 30b via the one or more fiber optic spans 24. The second primary node 14b includes a second transceiver module 18b, for example, that supplies a downstream optical signal having a plurality of subcarriers and a RF modulated tone 180, described in detail below, to the first fiber optic span 24-1, and receives an upstream signal having at least one reflection of the RF modulated tone 180 from the second fiber optic span 24-2 of the fiber optic spans 24.

In one embodiment, the second optical communication system 10b includes the one or more optical repeater 26a-n optically disposed between the second primary node 14b and the second secondary node 30b. The optical repeaters 26 may, in part, boost signals in the optical fiber submarine cable 20 as described above in more detail. The optical repeater 26 may be constructed as an “optical repeater” that receives, amplifies, and transmits the optical signals thereby increasing a transmission range of the optical signals.

In the second optical communication system 10b, one or more optical data carrier signals may be transmitted in one or more optical subcarrier (shown in FIG. 4 and discussed below) along with the tone subcarrier through the optical fiber submarine cable 20. In particular, selected subcarriers may be transmitted in the downstream direction from the second primary node 14b to the second secondary node 30b, and other subcarriers may be transmitted in the upstream direction from the second secondary node 30b to the second primary node 14b.

In some embodiments, the second optical communication system 10b may include one or more additional ones of the second primary node 14b and/or the second secondary node 30b and the optical fiber submarine cables 20, fewer of the second primary nodes 14b and/or the second secondary nodes 30b and the optical fiber submarine cables 20, or may have a configuration different from that described above. For example, the second optical communication system 10b may have a mesh configuration or a point-to-point configuration.

As shown in FIG. 1B, in one embodiment, the second transceiver module 18b may generally comprise one or more transmitter module 46 (hereinafter transmitter module 46) and one or more receiver module 50 (hereinafter receiver module 50) constructed as a coherent receiver and optically coupled to a ROADM 54. The second transceiver module 18b may further include an optical loopback 58 operable to be tuned to a particular wavelength and cause a portion of the optical signal at the tuned wavelength (e.g., having the RF modulated tone 180 of FIG. 4) to be sent from the transmitter module 46 towards the receiver module 50 (e.g., as the reflection). In some embodiments, the second transceiver module 18b may further include a narrowband filter 62 optically disposed between the ROADM 54, or when present the optical loopback 58, and the receiver module 50. When the narrowband filter 62 is present, the second transceiver module 18b may further include a phase detector 60 optically connected to the narrowband filter 62 to receive a filtered optical signal. In some embodiments, when the narrowband filter 62 is present, the narrowband filter 62 is operable to filter out a filter portion of a received optical signal corresponding to the RF modulated tone 180 and direct the RF modulated tone 180 to the phase detector 60. The narrowband filter 62 may, for example, has a bandwidth of 1.5 GHz.

In one embodiment, the second secondary node 30b is constructed similar to and may have a structure similar to and operate in a manner similar to that described above with respect to the second primary node 14b. For example, a second secondary transceiver 42b may be constructed in accordance with the second transceiver module 18b. In one example, however, a second secondary transceiver 42b may supply the optical signal in the upstream direction towards the second primary node 14b. The second secondary transceiver 42b may comprise, for example, the receiver module 52 constructed in accordance with the receiver module 50, the transmitter module 48 constructed in accordance with the transmitter module 46, and a ROADM 56 constructed in accordance with the ROADM 54. The second secondary transceiver 42b may further comprise the narrowband filter 62 and the phase detector 60.

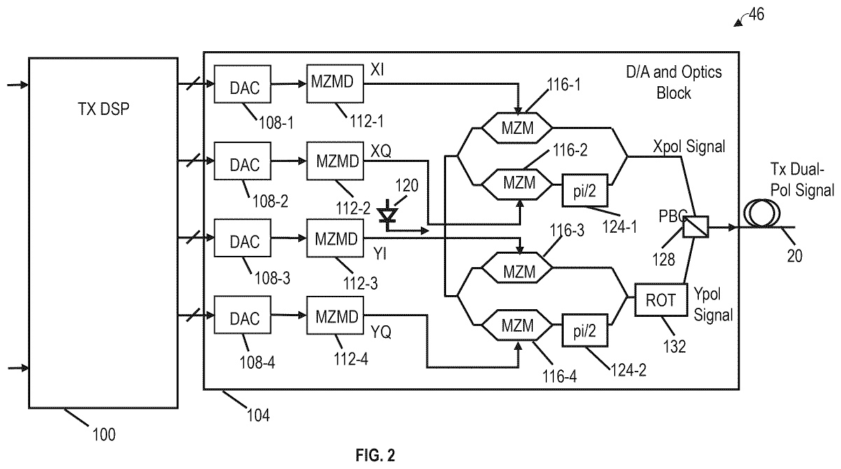

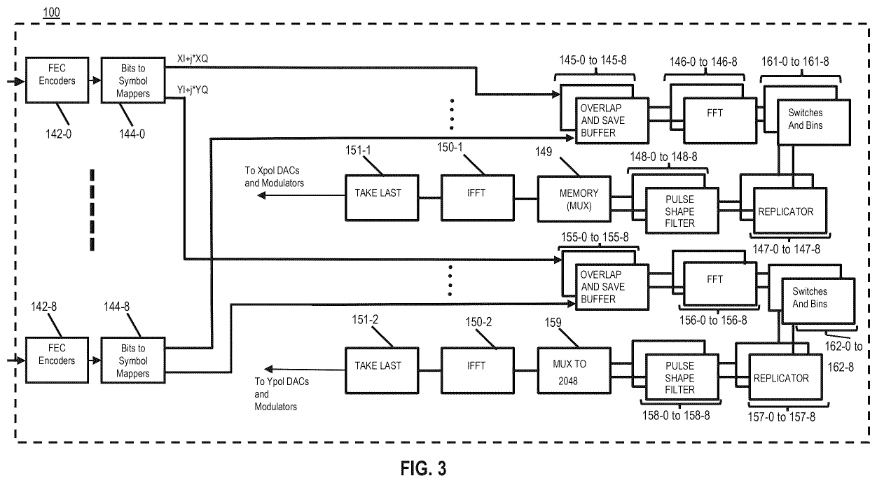

Referring now to FIG. 2, shown therein is a diagram of an exemplary embodiment of the transmitter module 46 constructed in accordance with the present disclosure. The transmitter module 46 generally includes a transmitter DSP 100 and a D/A and optics block 104. In one embodiment, each input to the transmitter DSP 100, such as the inputs to FEC encoders 142 described below (see FIG. 3), receives user data.

The D/A and optics block 104 may comprise one or more digital-to-analog conversion circuits 108, such as a first DAC circuit 108-1, a second DAC circuit 108-2, a third DAC circuit 108-3, and a fourth DAC circuit 108-4 (which may be referred to herein simply as DAC circuits 108). The D/A and optics block 104 may include driver circuits 112, such as a first driver circuit 112-1, a second driver circuit 112-2, a third driver circuit 112-3, and a fourth driver circuit 112-4. The D/A and optics block 104 may include modulators 116, such as a first modulator 116-1, a second modulator 116-2, a third modulator 116-3, and a fourth modulator 116-4. The D/A and optics block 104 may comprise an optical source 120. The D/A and optics block 104 may comprise one or more phase shifter 124, such as a first phase shifter 124-1 and a second phase shifter 124-2. The D/A and optics block 104 may comprise a polarization beam combiner 128. The D/A and optics block 104 may comprise a polarization rotator 132.

In one embodiment, the transmitter DSP 100 may supply a plurality of outputs to the D/A and optics block 104 including to the first, second, third, and fourth digital-to-analog conversion (DAC) circuits 108-1 to 108-4, which may convert a digital signal received from the transmitter DSP 100 into corresponding analog signals. The first, second, third, and fourth driver circuits 112-1 to 112-4 of the D/A and optics block 104 may receive the analog signals from the first, second, third, and fourth DAC circuits 108-1 to 108-4 and adjust the voltages or other characteristics thereof to provide drive signals to a corresponding one of the modulators 116-1 to 116-4. The modulators 116 are configured to encode data into the optical signal.

In one embodiment, the modulators 116-1 to 116-4 of the D/A and optics block 104 may be, for example, a Mach-Zehnder modulator (MZM) that modulates the phase and/or amplitude of the light output from an optical source such as an optical source 120. As further shown in FIG. 2, light output from the optical source 120 is split such that a first portion of the light is supplied to a first MZM pairing, including first and second MZMs 116-1 and 116-2, and a second portion of the light is supplied to a second MZM pairing, including third and fourth MZMs 116-3 and 116-4. The first portion of the light is split further into third and fourth portions, such that the third portion is modulated by the first MZM 116-1 to provide an in-phase (I) component of an X (or TE) polarization component of a modulated optical signal, and the fourth portion is modulated by the second MZM 116-2 and fed to the first phase shifter 124-1 to shift the phase of such light by 90 degrees in order to provide a quadrature (Q) component of the X polarization component of the modulated optical signal. Similarly, the second portion of the light is further split into fifth and sixth portions, such that the fifth portion is modulated by the third MZM 116-3 to provide an I component of a Y (or TM) polarization component of the modulated optical signal, and the sixth portion is modulated by the fourth MZM 116-4 and fed to the second phase shifter 124-2 to shift the phase of such light by 90 degrees to provide a Q component of the Y polarization component of the modulated optical signal.

The optical outputs of the first and second MZMs 116-1 and 116-2 are combined to provide an X polarized optical signal including I and Q components and are fed to the polarization beam combiner 128. In addition, the outputs of the third and fourth MZMs 116-3 and 116-4 are combined to provide an optical signal that is fed to the polarization rotator 132, that rotates the polarization of such optical signal to provide a modulated optical signal having a Y (or TM) polarization. The Y polarized modulated optical signal also is provided to the polarization beam combiner 128, which combines the X and Y polarized modulated optical signals to provide a polarization multiplexed (“dual-pol”) modulated optical signal onto an optical fiber, for example the first fiber optic span 24-1, which may be included as a segment of optical fiber in the optical fiber submarine cable 20.

The polarization multiplexed optical signal output from the D/A and optics block 104 includes the subcarriers SC0-SC7 described below, such that each subcarrier has X and Y polarization components and I and Q components. Moreover, the polarization multiplexed optical signal output from the D/A and optics block 104 may further include the RF modulated tone 180 having a polarization and the RF modulated tone described in more detail below with respect to FIG. 4.

It will be understood that fewer or more components may be included in the transmitter module 46.

Referring now to FIG. 3, shown therein is a diagram of an exemplary embodiment of the transmitter DSP 100 of FIG. 2 shown in greater detail and constructed in accordance with the present disclosure. The transmitter DSP 100 may include a plurality of FEC encoders 142, such as first through eighth FEC encoders 142-0 to 142-8 (collectively referred to herein as “FEC encoders 142”). The FEC encoders 142 carry out forward error correction coding on a corresponding one of the switch outputs, such as, by adding parity bits to the received data. The FEC encoders 142 may also provide timing skew between the subcarriers to correct for skew induced by link between the primary node 14 and the secondary node 30. In addition, the FEC encoders 142 may interleave the received data.

Each of the FEC encoders 142 provides an output to a corresponding one of a plurality of bits-to-symbol circuits 144-0 to 144-8 (collectively referred to herein as “bits-to-symbol circuits 144”). Each of the bits-to-symbol circuits 144 may map the encoded bits to symbols on a complex plane. For example, bits-to-symbol circuits 144 may map four bits to a symbol in a dual-polarization QPSK constellation. Each of bits-to-symbol circuits 144 provides first symbols, having the complex representation XI+j*XQ, associated with a respective one of the switch outputs, such as D-0, to DSP portion 143. Data indicative of such first symbols is carried by the X polarization component of each subcarrier SC0-SC7.

Each of the bits-to-symbol circuits 144 further may provide second symbols having the complex representation YI+j*YQ. Data indicative of such second symbols, however, is carried by the Y polarization component of each subcarrier SC0 to SC7.

Such mapping, as carried out by the bits-to-symbol circuits 144 defines, in one example, a particular modulation format for each subcarrier. That is, such circuit may define a mapping for all the optical subcarrier that is indicative of a binary phase shift keying (BPSK) modulation format, a quadrature phase shift keying (QPSK) modulation format, or an m-quadrature amplitude modulation (QAM, where m is a positive integer, e.g., 4, 8, 16, 32, 64, 128 or 256, for example) format. In another example, one or more of the optical subcarriers may have a modulation format that is different than the modulation format of other optical subcarriers. That is, one of the optical subcarriers have a QPSK modulation format and another optical subcarrier has a different modulation format, such as 8-QAM or 16-QAM. In another example, one of the optical subcarriers has an 8-QAM modulation format and another optical subcarrier has a 16 QAM modulation format. Accordingly, although all the optical subcarriers may carry data at the same data and/or baud rate, consistent with an aspect of the present disclosure one or more of the optical subcarriers may carry data at a different data and/or baud rate than one or more of the other optical subcarriers. Moreover, modulation formats, baud rates, and data rates may be changed over time depending on capacity requirements, for example. Adjusting such parameters may be achieved, for example, by applying appropriate signals to bits-to-symbol mappers (e.g., symbol circuits 144) based on control information or data described herein and the communication of such data as further disclosed herein between nodes.

As further shown in FIG. 3, each of the first symbols output from each of the bits-to-symbol circuit 144 is supplied to a respective one of first overlap and save buffers 145-0 to 145-8 (collectively referred to herein as overlap and save buffers 145) that may buffer 256 symbols, for example. Each overlap and save buffer 145 may receive 128 of the first symbols or another number of such symbols at a time from a corresponding one of bits to symbol circuits 144. Thus, the overlap and save buffers 145 may combine 128 new symbols from bits to symbol circuits 144, with the previous 128 symbols received from the bits to symbol circuits 144.

Each overlap and save buffer 145 supplies an output, which is in the time domain, to a corresponding one of first fast Fourier Transform (FFT) circuits 146-0 to 146-8 (collectively referred to as “first FFTs 146”). In one example, the output includes 256 symbols or another number of symbols. Each of the first FFTs 146 converts the received symbols to the frequency domain using or based on, for example, a fast Fourier transform. Each of the first FFTs 146 may provide the frequency domain data to first switches and bins circuit blocks 161-0 to 161-8. The first switches and bins circuit blocks 161 include, for example, memories or registers, also referred to as frequency bins (FB) or points, that store frequency components associated with each subcarrier SC and the RF modulated tone 180.

The first switches and bins circuit blocks 161 may be configured to supply the outputs of the first FFTs 146, i.e., frequency domain data FD, to corresponding frequency bins FB. Further processing of the contents of frequency bins FB by first replicator components 147 and other circuits in the transmitter DSP 100 result in drive signals supplied to the modulators 116, whereby, based on such drive signals, optical subcarriers are generated that correspond to the frequency bin groupings associated with that subcarrier and/or the RF modulated tone 180.

In the example discussed above, the first switches and bins circuit blocks 161 supply frequency domain data FD0-0 to FD-n from the first FFT 146-0 to a respective one of the frequency bins FB0-0 to FB0-n for further processing, as described in greater detail below.

Each of the first replicator components 147-0 to 147-8 may replicate the contents of the frequency bins FB and store such contents (e.g., for T/2 based filtering of the subcarrier or optical tone) in a respective one of the plurality of replicator components. Such replication may increase the sample rate. In addition, the first replicator components 147-0 to 147-8 may arrange or align the contents of the frequency bins to fall within the bandwidths associated with first pulse shaped filter circuits 148-0 to 148-8 (collectively referred to herein as first pulse shaped filter circuits 148) described below.

Each first pulse shape filter circuit 148 may apply a pulse shaping filter to the data stored in the 512 frequency bins of a respective one of the plurality of first replicator components 147-0 to 147-8 to thereby provide a respective one of a plurality of filtered outputs, which are multiplexed and subject to an inverse FFT, as described below. The first pulse shape filter circuits 148 calculate the transitions between the symbols and the desired subcarrier spectrum so that the subcarriers can be packed together spectrally for transmission, e.g., with a close frequency separation. The first pulse shape filter circuits 148 also may be used to introduce timing skew between the subcarriers to correct for timing skew induced by links between nodes shown in FIG. 1, for example. A first multiplexer component 149 of the transmitter DSP 100, which may include a multiplexer circuit or memory, may receive the filtered outputs from the first pulse shape filter circuits 148, and multiplex or combine such outputs together to form an element vector. In one embodiment, at least one of the first pulse shape filter circuits 148 may introduce a timing skew to separate the tone signal from the subcarriers such that the tone signal is separated from, and thus less likely to interfere with, the subcarriers.

Next, a first IFFT circuit 150-1 of the transmitter DSP 100 may receive the element vector and provide a corresponding time domain signal or data based on an inverse fast Fourier transform (IFFT). In one example, the time domain signal may have a rate of 64 GSample/s. A first take last buffer or memory circuit 151-1 of the transmitter DSP 100, for example, may select the last 1024 samples, or another number of samples, from an output of the first IFFT circuit 150-1 and supply the samples to the DAC circuits 108-1 and 108-2 (see FIG. 2) at 64 Gsample/s, for example. As noted above, the first DAC circuit 108-1 is associated with the in-phase (I) component of the X pol signal, and the second DAC circuit 108-2 is associated with the quadrature (Q) component of the Y pol signal. Accordingly, consistent with the complex representation XI+jXQ, the first DAC circuit 108-1 receives values associated with XI and the second DAC circuit 108-2 receives values associated with jXQ. As indicated by FIG. 2, based on these inputs, the first and second DAC circuits 108-1 and 108-2 provide analog outputs to the first and second MZMD 112-1 and MZMD 112-2, respectively, as discussed above.

As further shown in FIG. 3, each of the bits-to-symbol circuits 144 outputs a corresponding one of symbols indicative of data carried by the Y polarization component of the polarization multiplexed modulated optical signal output on optical fiber submarine cable 20. As further noted above, these symbols may have the complex representation YI+j*YQ. Each such symbol may be processed by a respective one of second overlap and save buffers 155-0 to 155-8 (collectively referred to herein as overlap and save buffers 155), a respective one of second FFT circuits 156-0 to 156-8 (collectively referred to as “second FFTs 156”), a respective one of second switches and bins components 162-0 to 162-8, a respective one of second replicator components 157-0 to 157-8, second pulse shape filter circuits 158-0 to 158-8, second multiplexer 159, second IFFT 150-2, and second take last buffer or memory circuit 151-2, to provide processed symbols having the representation YI+j*YQ in a manner similar to or the same as that discussed above in generating processed symbols XI+j*XQ output from the first take last circuit 151-1. In addition, symbol components YI and YQ are provided to third DAC circuit 108-3 and fourth DAC circuit 108-4 (FIG. 2), respectively. Based on these inputs, the third and fourth DAC circuits 108-3 and 108-4 provide analog outputs to the third MZMD 112-3 and the fourth MZMD 112-4, respectively, as discussed above.

While FIG. 3 shows the transmitter DSP 100 as including a particular number and arrangement of functional components, in some embodiments, the transmitter DSP 100 may include additional functional components, fewer functional components, different functional components, or differently arranged functional components. In addition, typically the number of first overlap and save buffers 145, first FFT 146, first replicator components 147, and first pulse shape filter circuits 148 associated with the X component may be equal to the number of switch outputs, and the number of such circuits associated with the Y component may also be equal to the number of switch outputs. However, in other examples, the number of switch outputs may be different from the number of these circuits.

As noted above, based on the outputs of the first, second, third, and fourth MZMDs 112-1 to 112-4, a plurality of optical subcarriers SC0 to SC7 may be output onto optical fiber submarine cable 20 (FIG. 2), which is optically coupled to the primary node 14.

Consistent with an aspect of the present disclosure, the number of subcarriers transmitted from the primary node 14 to the secondary node 30 may vary over time based, for example, on capacity requirements at the primary node 14 and the secondary node 30. For example, if less downstream capacity is required initially at one or more of the secondary nodes 30, transmitter module 46 in primary node 14 may be configured to output fewer optical subcarriers. On the other hand, if further capacity is required later, transmitter module 46 may provide more optical subcarriers.

In addition, if based on changing capacity requirements, a particular secondary node 30 needs to be adjusted, for example, the output capacity of the particular secondary node 30 may be increased or decreased by, in a corresponding manner, increasing or decreasing the number of optical subcarriers output from the particular secondary node 30.

As noted above, by storing and subsequently processing zeros (0s) or other predetermined values in frequency bin FB groupings associated with a given subcarrier SC, that subcarrier may be removed or eliminated. To add or reinstate such subcarrier, frequency domain data output from the first FFTs 146 may be stored in frequency bins FB and subsequently processed to provide the corresponding subcarrier. Thus, optical subcarriers may be selectively added or removed from the optical outputs of the transmitter module 46 of the primary node 14, and the transmitter module 48 of the secondary node 30, such that the number of optical subcarriers output from the transmitter modules 46 may be varied, as desired.

In the above example, zeros (0s) or other predetermined values are stored in selected frequency bins FBs to prevent transmission of a particular optical subcarrier SC. Such zeroes or values may, instead, be provided, for example, in a manner similar to that described above, at the outputs of corresponding ones of the first replicator components 147 or stored in corresponding locations in the first multiplexer component 149. Alternatively, the zeroes or values noted above may be provided, for example, in a manner similar to that described above, at corresponding outputs of the first pulse shape filter circuits 148.

In a further example, a corresponding one of first pulse shape filter circuits 148 may selectively generate zeroes or predetermined values that, when further processed, also cause one or more optical subcarriers SC to be omitted from the optical signal output from either the transmitter module 46 or the transmitter module 48. In particular, first pulse shape filter circuits 148 may include groups of multiplier circuits M. Multiplier circuits M constitutes part of a corresponding butterfly filter. In addition, each multiplier circuit grouping is associated with a corresponding one of optical subcarriers SC.

Each multiplier circuit M receives a corresponding one of output groupings RD from the first replicator components 147. In order to remove or eliminate one of optical subcarriers SC, multiplier circuits M receiving the outputs within a particular grouping associated with that optical subcarrier multiply such outputs by zero (0), such that each multiplier M within that group generates a product equal to zero (0). The zero products then are subject to further processing similar to that described above to provide drive signals to the modulators 116 that result in a corresponding optical subcarrier SC being omitted from the optical signal output from the transmitter module 46.

On the other hand, in order to provide an optical subcarrier SC, each of the multiplier circuits M within a particular groping may multiply a corresponding one of replicator outputs RD by a respective one of coefficients C, which results in at least some non-zero products being output. Based on the products output from the corresponding multiplier grouping, drive signals are provided to the modulators 116 to output the desired optical subcarrier SC from the transmitter module 46.

Accordingly, for example, in order to block or eliminate a second optical subcarrier SC1 (e.g., to “turn off” SC1), each of multiplier circuits M (associated with the second optical subcarrier SC1) multiplies a respective one of replicator outputs RD by zero (0). Each such multiplier circuit, therefore, provides a product equal to zero, which is further processed, as noted above, such that resulting drive signals cause the modulators 116 to provide an optical signal output without the second optical subcarrier SC1. In order to reinstate the second optical subcarrier SC1, multiplier circuits M multiply a corresponding one of appropriate coefficients C by a respective one of replicator outputs RD to provide products, at least some of which are non-zero. Based on these products, as noted above, modulator drive signals are generated that result in the second optical subcarrier SC1 being output.

The above examples are described in connection with generating or removing the X component of an optical subcarrier SC. The processes and circuitry described above is employed or included in the transmitter DSP 100 and optical circuitry used to generate the Y component of the optical subcarrier to be blocked. For example, second switches and bins circuit blocks 162-0 to 162-8, have a similar structure and operate in a similar manner as the first switches and bins circuit blocks 161 described above to provide zeroes or frequency domain data as the case may be to selectively block the Y component of one or more optical subcarriers SC. Alternatively, multiplier circuits, like those described above may be provided to supply zero products output from selected second pulse shape filters 158 in order to block the Y component of a particular optical subcarrier or, if non-zero coefficients are provided to the multiplier circuits instead, generate the optical subcarrier.

Thus, the above examples illustrate mechanisms by which optical subcarriers SC may be selectively blocked from or added to the optical signal output from the transmitter module 46. Since, as discussed below, DSPs and optical circuitry provided in the secondary node 30 transmitter module 48 are similar to that of primary node 14 transmitter module 46, the processes and circuitry described above is provided, for example, in the secondary node 30 transmitter module 48 to selectively add and remove optical subcarriers SC from the outputs of the secondary node 30 transmitter modules 48.

As described above in more detail, the transmitter module 46 may thus include the RF modulated tone 180 outside the bandwidth of the optical subcarriers SC0-SC7 into the optical signal transmitted from the primary node 14. The RF modulated tone 180, therefore, has an initial frequency (f8), an initial RF amplitude modulation, and an initial RF phase that is known at the time the optical signal is transmitted. Additionally, the RF modulated tone 180 may be associated with an initial time at which the RF modulated tone 180 is first transmitted. In some embodiments, the RF modulated tone 180 is not modulated with any data. Similarly, a particular one of the optical subcarriers SC0-SC7 may include the test subcarrier having the RF modulated tone 180.

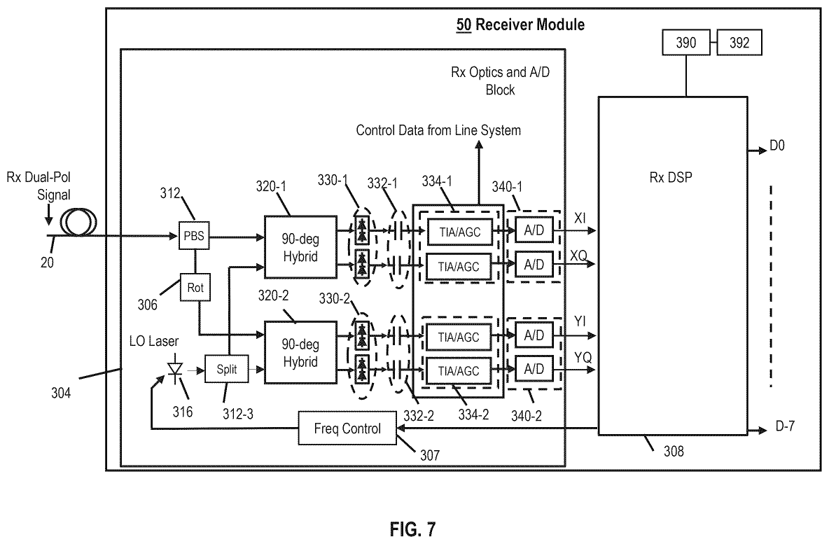

Optical signals including optical subcarriers SC0 to SC7, the test subcarrier, and an optical tone reflection of the RF modulated tone 180 may be provided from the secondary node 30 to the primary node 14. An example of the receiver module 50 in the primary node 14 will be described below with reference to FIG. 7.

Referring now to FIG. 4, shown therein is a diagram of an exemplary embodiment of a plurality of subcarriers, SC0 to SC7 that may be output by the transmitter module 46 of a transceiver module 18 consistent with an aspect of the present disclosure. Each of subcarriers SC0 to SC7 may have a corresponding one of a plurality of frequencies f0 to f7. In addition, each of subcarriers SC0 to SC7 may be a Nyquist subcarrier. A Nyquist subcarrier is a group of optical signals, each carrying data, wherein (i) the spectrum of each such optical signal within the group is sufficiently non-overlapping such that the optical signals remain distinguishable from each other in the frequency domain, and (ii) such group of optical signals is generated by modulation of light from a single laser. In general, each subcarrier SC may have an optical spectral bandwidth that is at least equal to the Nyquist frequency, as determined by the baud rate of such subcarrier.

As discussed in greater detail above, optical subcarriers SC0 to SC7 are generated by modulating light output from a laser. The frequency of such laser output light is f′ and is typically a center frequency such that half the subcarrier subcarriers, e.g., f4 to f7, are above f′ and half the subcarrier frequencies, e.g., f0 to f3, are below f′.

Further shown in FIG. 4 is the RF modulated tone 180. The RF modulated tone 180 may be generated, for example by one or more of the TX DSP 100 sending a signal to the DAC circuits 108 to cause the MZMD 112 to generate a signal corresponding to the RF modulated tone 180 to be generated by the MZM 116. The RF modulated tone 180 may thus be an optical signal having an RF signal (e.g., an RF amplitude modulation) applied thereto. Therefore, RF phase refers to the phase of the RF signal applied to the optical signal and does not refer to the optical phase of the optical signal. In one embodiment, the RF modulated tone 180 is generated at a tone frequency f8 outside the carrier bandwidth between f0-f7 as shown in FIG. 4.

It should be noted that while the RF modulated tone 180 is shown at a frequency lesser than the carrier bandwidth, e.g., lesser than f0, in other embodiments, the RF modulated tone 180 could be generated such that the RF modulated tone 180 is at a tone frequency f8 outside the carrier bandwidth but greater than the frequency for SC7 at f7. The tone frequency f8 of the RF modulated tone 180 may be selected to align to the fiber Bragg grating 39 of the high loss loopback 38. The RF modulated tone 180, as shown in FIG. 4, may have an initial frequency, initial amplitude modulation (e.g., RF phase), and initial polarization that is known at the time the optical signal is transmitted.

In one embodiment, the tone frequency f8 of the RF modulated tone 180 is generated at a frequency more than 500 MHz outside the carrier bandwidth, e.g., at a frequency at least 500 MHz less than f0 or at least 500 MHz more than f7.

In one embodiment, the RF modulated tone 180 is one or more of a pulsed optical signal (e.g., a signal transmitted periodically in predetermined intervals), or a per pol signal (e.g., a signal consisting of only one polarization). When the RF modulated tone 180 is pulsed, the RF modulated tone 180 may be included with the optical signal at a first instant of time and at a second instant of time such that the RF modulated tone 180 pulsed at the second instant of time does not interfere with the RF modulated tone 180 pulsed at the first instant of time or optical reflections of the RF modulated tone 180 pulsed at the first instant of time.

In one embodiment, the RF modulated tone 180 has a pulse width selected based on a desired spatial resolution. In some embodiments, the RF modulated tone 180 has an RF amplitude module applied thereto with a bandwidth of 90 MHz. In some embodiments, the RF modulated tone 180 has a bandwidth of between about 10 MHz and about 100 MHz. In one embodiment, when the receiver module 50 is a coherent receiver, the RF modulated tone 180 may have a bandwidth of at least 1 GHz and less than about 12.5 GHz.

In one embodiment, the RF modulated tone 180 has a tone frequency f8 between two subcarriers, such as between SC0 and SC1, for example, such that the tone frequency f8 may be intermediate f0 and f1, but outside the subcarriers SC0 and SC1. Similarly, the RF modulated tone 180 may have a tone frequency f8 between any two, adjacent subcarriers. In this way. The RF modulated tone 180 may be included into the optical signal without interfering with data carried on the subcarriers SC0-SC7.

In one embodiment, more than one RF modulated tone 180 may be included in the optical signal. For example, a first RF modulated tone may be included between f0 and f1 while a second RF modulated tone may be included at f8. In one embodiment, a RF modulated tone 180 may be included at a tone frequency less than f0, greater than f7, and between each subcarrier SC0-SC7.

In one embodiment, the RF modulated tone 180 may be positioned at one of frequencies f0-f7 and the respective subcarrier SC0-7 may be deactivated. For example, the RF modulated tone 180 may be positioned at the frequency f0 and the subcarrier SC0 may be deactivated such that no data other than the RF modulated tone 180 is activated within the bandwidth of the subcarrier SC0.

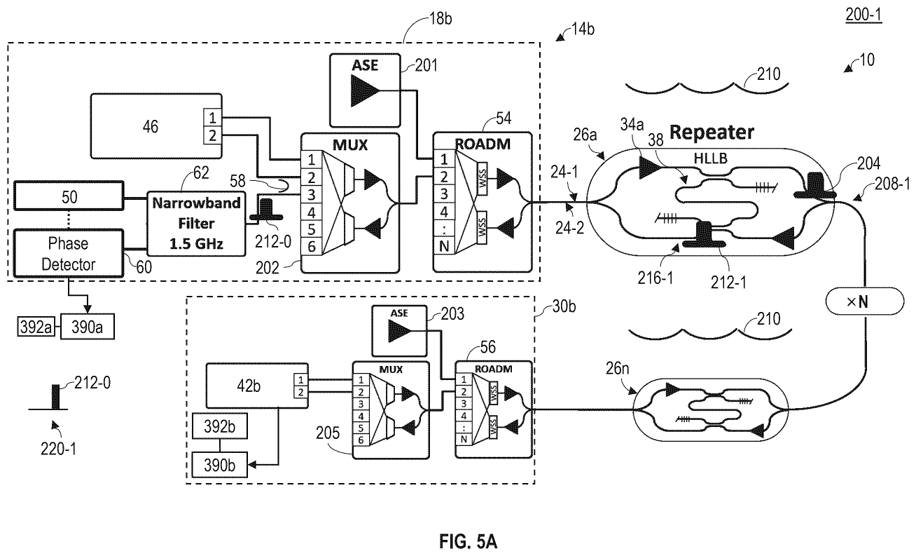

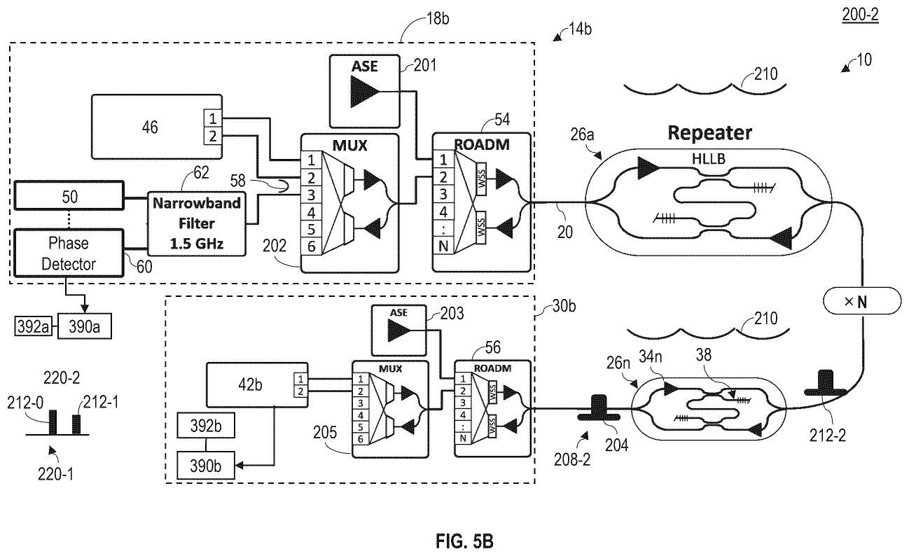

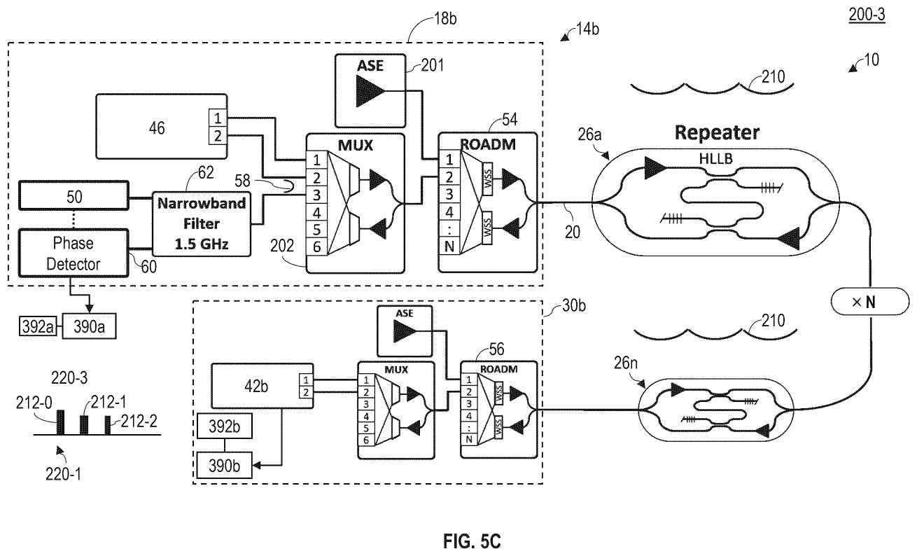

Referring now to FIGS. 5A-5C in combination, shown therein is the optical communication system 10 of FIG. 1 at different instances of time 200 depicting one or more of a pulse 204, an HLLB spectrum location 208, a pulse reflection 212, an HLLB spectrum reflection location 216, and a time-series graph 220 (shown as time-series graph 220-1 at a first instance of time 200-1 in FIG. 5A) of the pulse reflection 212. The pulse 204 may be a particular instance of the RF modulated tone 180 as described in detail above.

Referring now to FIG. 5A, shown therein is the second optical communication system 10b of FIG. 1B at a first instance of time 200-1. As shown, at the first instance of time 200-1, the pulse 204, after having traveled along the first fiber optic span 24-1, passing through the high loss loopback 38 of a first optical repeater 26a, at a first HLLB spectrum location 208-1, generates a first Pulse reflection 212-1 (shown at a first HLLB spectrum reflection location 216-1) traveling upstream towards the second primary node 14b along the second fiber optic span 24-2. The second primary node 14b may further include a number of optical components, such as a light source 201, a multiplexer/demultiplexer 202, and the ROADM 54. In this way, the pulse 204 traveling between the second primary node 14b and the first optical repeater 26a may experience RF phase changes, for example, as caused by an environmental disturbance 210. These RF phase changes may affect the RF modulated tone 180 of the pulse 204. The RF phase changes may further affect the RF modulated tone 180 of the first pulse reflection 212-1 as the first pulse reflection 212-1 further passes through the second fiber optic span 24-2 traveling upstream from the first optical repeater 26a to the second primary node 14b.

In some embodiments, the environmental disturbance(s) 210 may include, for example, an earthquake, a temperature, a pressure, a wave, a tsunami, ground movement, and/or the like. The environmental disturbance 210 may include, for example, seismic pressures on the fiber optic span 24.

As further shown in FIG. 5A, a local pulse reflection 212-0 is shown having been reflected from the optical signal by the optical loopback 58. The local pulse reflection 212-0 may include the RF modulated tone 180 as transmitted by the transmitter module 46 prior to experiencing any RF phase change, e.g., due to the environmental disturbance 210.

In one embodiment, the first pulse reflection 212-1 is received by the receiver module 50 (shown in FIG. 7) and processed by a receiver DSP 308 (FIG. 7) and stored, as discussed below in more detail. A representation of the local pulse reflection 212-0 is shown in the time-series graph 220-1 in FIG. 5A.

In one embodiment, the second primary node 14b further includes a first DSP 390a in communication with the second transceiver module 18b and a first memory 392a. The first memory 392a may be a non-transitory, processor-readable memory which may store processor-executable instructions and/or data, such as in a database, or other computer readable structure, for example. In one embodiment, the first DSP 390a is in communication with and may receive from the second transceiver module 18b of the second primary node 14b (e.g., from the phase detector 60) an indication of an RF phase of each pulse reflection 212, for example, relative to the RF modulated tone 180 of the pulse 204. The first DSP 390a may store the indication of the RF phase of each pulse reflection 212 in the first memory 392a.

In one embodiment, the first DSP 390a and the first memory 392a are integrated into, or otherwise a part of, the receiver DSP 308 of the primary node 14 as discussed below.

In one embodiment, the first memory 392a stores the processor-executable instructions that when executed by the first DSP 390a, causes the first DSP 390a to communicate and/or exchange data with one or more of the second transceiver modules 18b and/or one or more component of the second transceiver module 18b of the second primary node 14b and to further implement the functions described below in more detail.

In one embodiment, the local tone reflection 212-0 and the first tone reflection 212-1 pass through the narrowband filter 62 and are received by the phase detector 60. The first DSP 390a of the receiver DSP 308 may receive a signal from the phase detector 60 indicative of an optical power (e.g., amplitude) of the optical signal of each pulse reflection 212. The first DSP 390a may process the optical power for each pulse reflection 212 to determine an RF phase for each pulse reflection 212. In one embodiment, the phase detector 60 may comprise a photodetector (such as a photodiode, for example) configured to generate a power signal indicative of an optical power of the received pulse reflection 212 and a digital-to-analog converter (e.g., a DAC) operable to measure the photodetector and generate a stream of optical power measurement data. The first DSP 390a, by processing the stream of data from the DAC may calculate an RF phase for each pulse reflection. In some embodiments, the phase detector 60 may further comprise a polarimeter operable to determine a polarization of each pulse reflection 212.

In one embodiment, the first DSP 390a may store tone data indicative of the RF phase associated with each pulse reflection 212 in the first memory 392a. Exemplary tone data may include, for example only, the RF phase, an indication of an associated fiber optic span 24, a first timestamp indicative of a time during which the tone reflection traveled across the associated optical fiber link, a second timestamp indicative of a time at which the phase detector 60 received the pulse reflection 212, a third timestamp indicative of a time at which the second secondary transceiver 42b received the pulse 204, a time-delta indicative of a difference in time between the second timestamp and a time at which the phase detector 60 received the local tone reflection 212-0 from the optical loopback 58, and the like, or a combination thereof. In one embodiment, the tone data may be stored in a database or other computer readable structure in the first memory 392a, whereas in other embodiments, the tone data may be stored in a data buffer or, in some embodiments, sent via a network element to another processor, computer, or server, for example.

In one embodiment, the first DSP 390a may determine a difference in RF phase between two sequential pulse reflections 212 to detect localized changes in pressure or temperature of the fiber optic span 24 associated with the latter of the sequential pulse reflection 212. For example, the first tone reflection 212-1 may be associated with the first and second fiber optic spans 24-1 and 24-2 because the first and second fiber optic spans 24-1 and 24-2 are the fiber optic spans 24 immediately upstream of the HLLB 38 that generated the first tone reflection 212-1.

In some embodiments, the second secondary node 30b further includes the narrowband filter 62, the phase detector 60, the DSP 390b, and the memory 392b, each of which is similar to and operates in accordance with the same components described in relation to the second primary node 14b. In some embodiments, the first DSP 390a in the second primary node 14b may be in communication with the DSP 390b in the second secondary node 30b to jointly process the determined RF phase and/or one or more additional RF modulated tone information in optical signals in both the upstream and the downstream directions. In this way, a precision and/or quality of the determined RF phase, the tone data, and/or the one or more additional tone reflection information may be improved to better locate environmental disturbances 210 on or near the optical communication system 10.

Referring now to FIG. 5B, shown therein is the optical communication system 10 of FIG. 1B at a second instance of time 200-2. As shown, at the second instance of time 200-2, the pulse 204 has a second HLLB spectrum location 208-2 between the optical repeater 26n and the second secondary node 30b. At this second instance of time 200-2, the pulse 204 has already passed the high loss loopback 38 of the optical repeater 26n, resulting in a second pulse reflection 212-2 heading upstream towards the second primary node 14b. At the second instance of time 200-2, the first pulse reflection 212-1 has already been received by the receiver module 50 and the phase detector 60 of the second transceiver module 18b in the second primary node 14b and the receiver DSP 308 has determined an RF phase of the first pulse reflection 212-1. A representation of the first pulse reflection 212-1 is shown in the time-series graph 220-2 in FIG. 5B.

In one embodiment, the first DSP 390a of the second primary node 14b is in communication with and may receive from the receiver DSP 308 an indication of the RF phase the first pulse reflection 212-1. The first DSP 390a, in communication with the receiver DSP 308, determines the RF phase of the first pulse reflection 212-1 and stores the RF phase in the first memory 392a as described above in more detail.

Referring now to FIG. 5C, shown therein is the optical communication system 10 of FIG. 1B at a third instance of time 200-3. As shown, at the third instance of time 200-3, the pulse 204 has been received by the second secondary node 30b. At the third instance of time 200-3, the second Pulse reflection 212-2 has been received by the receiver module 50 and the phase detector 60 of the second transceiver module 18b of the second primary node 14b, as depicted in time-series graph 220-3. In one embodiment, the receiver DSP 308 has determined the RF phase of the second pulse reflection 212-2.

In one embodiment, the first DSP 390a of the second primary node 14b is in communication with and may receive from the receiver DSP 308 an indication of the RF phase the second pulse reflection 212-2. The first DSP 390a, in communication with the receiver DSP 308, determines the RF phase of the second pulse reflection 212-2 and stores the RF phase in the first memory 392a as described above in more detail.

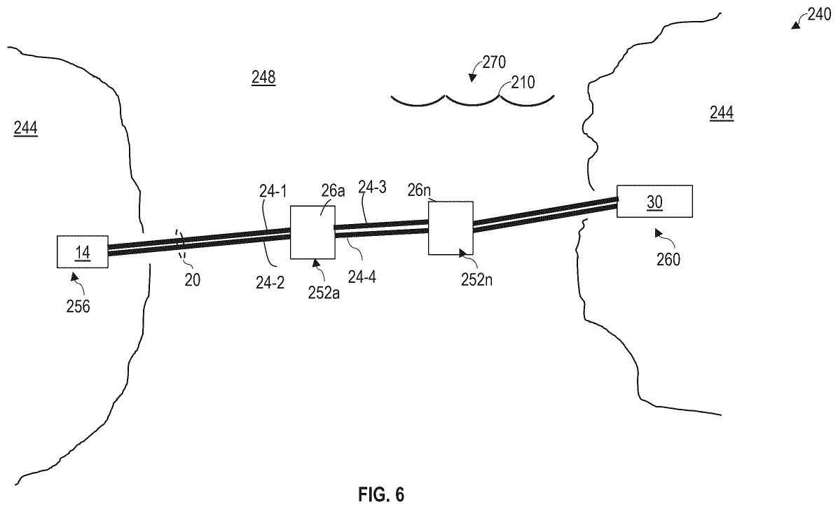

In one embodiment, the first DSP 390a stores the RF phase with one or more additional spectrum reflection information as tone data, as described above. The time-delta may be, for example, a time difference between a time at which the phase detector 60 received the local pulse reflection 212-0 and any other pulse reflection 212 or may be a time difference between a time at which the phase detector 60 received a particular pulse reflection 212 and a subsequent pulse reflection 212. In each of the above cases, the first DSP 390a of the second primary node 14b can determine a time traveled by a particular pulse reflection 212 to determine a particular distance traveled by the particular pulse reflection 212 as described below in reference to FIG. 6. Receiving, by the phase detector 60, the local pulse reflection 212-0 at a first instance of time, the first pulse reflection 212-1 at the second instance of time, and the second pulse reflection 212-2 at the third instance of time may be considered, for example, a stream of pulses separated in time where each pulse is a particular pulse reflection 212.

In one embodiment, a time between when the second transceiver module 18b transmits the RF modulated tone 180 of a first pulse 204 and when the second transceiver module 18b transmits the RF modulated tone 180 of a second pulse 204 may be considered a duty cycle. The duty cycle may be determined, for example, based on an amount of time equal (or greater than) twice an optical signal transit time, or a time it takes for the optical signal sent from the second primary node 14b to be received by the second secondary node 30b and reflected back to the second primary node 14b. The duty cycle may be, for example, about 100 ms, depending on a distance between the second primary node 14b and the second secondary node 30b. The duty cycle may be determined, for example, by testing the optical communication system 10 for the optical signal transit time and adding an offset to the optical signal transit time. In some embodiments, the offset may be between about 1 ms to about 5 ms in order to ensure that each pulse reflection 212 is associated with a particular pulse 204 that caused the received respective pulse reflection 212.

In one embodiment, the first DSP 390a is further in communication with the transmitter module 46 and, once the first DSP 390a has stored the RF phase with the tone data for a last pulse reflection 212, e.g., a pulse reflection 212 caused by the high loss loopback 38 optically disposed immediately prior/upstream to the second secondary node 30b, the first DSP 390a may send a signal to the transmitter module 46 to cause the transmitter module 46 to send the RF modulated tone 180 in a second pulse 204.

It should be understood that while only three pulse reflections 212 are described in relation to FIGS. 5A-5C, the number of HLLB spectrum reflections in the optical communication system 10 may be at least equal to one plus the number of optical repeaters 26 (having the high loss loopback 38) between the second primary node 14b and the second secondary node 30b.

Additionally, while the FIGS. 5A-5C illustrate only one pulse reflection 212 in the optical communication system 10 at each instance of time 200 for simplicity, any number of pulse reflections 212 may be present in the optical communication system 10 at each instance of time 200 based on a distance between the optical repeaters 26 and a number of optical repeaters 26. In one embodiment, the number of pulse reflections 212 present in the optical communication system 10 at any instance of time 200 may be dependent on a number of the optical repeaters 26 present in the optical communication system 10 and a distance of each fiber optic span 24 between each of the optical repeaters 26.

As shown in reference to FIGS. 5A-C, in this way, the second primary node 14b can receive each pulse reflection 212 caused by the pulse 204 being reflected upstream at each optical repeater 26 by the respective high loss loopbacks 38.

Referring now to FIG. 6, shown therein is a diagram of an exemplary embodiment of a subsea optical communication system 240 constructed in accordance with the present disclosure. The subsea optical communication system 240 may be constructed similar to the first optical communication system 10a of FIG. 1A or the second optical communication system 10b of FIG. 1B. The subsea optical communication system 240 illustrates the primary node 14 and the secondary node 30 being on land 244 while the optical repeaters 26, shown as the first optical repeater 26a and the optical repeater 26n, are illustrated as being submerged under water 248. Each optical repeater 26 is shown to have a known geographic location 252, e.g., a known location 252a for the first optical repeater 26a and a known location 252n for the optical repeater 26n. The known geographic location 252 can be expressed in latitude/longitude. Moreover, each node has a known location, e.g., the primary node 14 and the secondary node 30, have a known primary location 256 and a known secondary location 260, respectively. Thus, each fiber optic span 24 has a known length based on a distance between respective known locations.

Therefore, when the pulse 204 is transmitted downstream, i.e., from the primary node 14 towards the secondary node 30, thus generating the pulse reflection at each of the optical repeaters 26, the primary node 14 can measure a duration between each instance of time 200 to determine a distance traveled for each pulse reflection 212. In this way, any change in RF phase between the local pulse reflection 212-0 and each pulse reflection 212, or between successive pulse reflections 212, can be correlated to a particular distance travelled along the fiber optic spans 24, and thus, to a particular one of the fiber optic spans 24 over which the RF phase may have changed. By comparing changes between multiple fiber optic spans 24, the DSP 390 may identify a location 270 of the environmental disturbance(s) 210. Further, by comparing changes in the RF phase for each fiber optic span 24 over a period of time, the DSP 390 may identify a RF phase change baseline for each fiber optic span 24.

Referring now to FIG. 7, shown therein is the receiver module 50 of the primary node 14 including an Rx optics and A/D block 304, which, in conjunction with the receiver DSP 308, may carry out coherent detection. Rx optics and A/D block 304 may include a polarization beam splitter 312 (PBS) with first and second outputs, a local oscillator laser 316 (i.e., LO laser), 90 degree optical hybrids or hybrid mixers 320 (referred to generally as hybrid mixers 320 and individually as hybrid mixer 320) shown as a first hybrid mixer 320-1 and a second hybrid mixer 320-2, a first detector 330-1 and a second detector 330-2 (referred to generally as detectors 330 and individually as detector 330, each including either a single photodiode or balanced photodiode), a first AC coupling capacitor 332-1 and a second AC coupling capacitor 332-2, transimpedance amplifiers/automatic gain control circuits 334 (referred to as TIA/AGCs 334 and shown as a first TIA/AGC 334-1 and a second TIA/AGC 334-2, ADCs 340 shown as a first ADC 340-1 and a second ADC 340-2 (referred to generally as ADCs 340 and individually as ADC 340).

The polarization beam splitter 312 may include a polarization splitter that receives an input polarization multiplexed optical signal including the optical subcarriers SC0 to SC7 and the RF modulated tone 180 carried along the fiber optic spans 24, for example. The polarization beam splitter 312 may split the incoming optical signal into the two X- and Y-orthogonal polarization components. The Y component may be supplied to a polarization rotator 306 that rotates the polarization of the Y component to have the X polarization. Hybrid mixers 320 may combine the X and rotated Y polarization components with light from local oscillator laser 310, which, in one example, is a tunable laser. For example, the first hybrid mixer 320-1 may combine a first polarization signal (e.g., the component of the incoming optical signal having a first or X (TE) polarization output from a first PBS port with light from local oscillator laser 316, and the second hybrid mixer 320-2 may combine the rotated polarization signal (e.g., the component of the incoming optical signal having a second or Y (TM) polarization output from a second PBS port) with the light from local oscillator laser 316. In one example, the polarization rotator 306 may be provided at the PBS output to rotate Y component polarization to have the X polarization.

The detectors 330 may detect mixing products output from the hybrid mixers 320, to form corresponding voltage signals, which are subject to AC coupling by capacitors 332, as well as amplification and gain control by TIA/AGCs 334. The outputs of the TIA/AGCs 334 and the ADCs 340 may convert the voltage signals to digital samples. For example, two first detectors 330-1 (e.g., photodiodes) may detect the X polarization signals to form the corresponding voltage signals, and a corresponding two first ADCs 340-1 may convert the voltage signals to digital samples for the first polarization signals after amplification, gain control and AC coupling. Similarly, two second detectors 330-2 may detect the rotated Y polarization signals to form the corresponding voltage signals, and a corresponding two second ADCs 340-2 may convert the voltage signals to digital samples for the second polarization signals after amplification, gain control and AC coupling. The receiver DSP 308 may process the digital samples associated with the X and Y polarization components to output data associated with one or more subcarriers within a group of the subcarriers SC0 to SC7 encompassed by the bandwidth associated with the secondary node 30 housing the receiver DSP 308.

In one embodiment, when the RF modulated tone 180 is positioned within a particular subcarrier of the subcarriers SC0-7, such as within the subcarrier SC0, the receiver module 50 may determine the RF phase of the RF modulated tone 180 in the respective pulse reflection 212, such as with the respective detector 330 and the respective ADC 340 associated with the particular subcarrier. Determining the RF phase of the RF modulated tone 180 utilizing the receiver module 50 may be preferable when the optical communication system 10 does not include the phase detector 60 and/or the narrowband filter 62, such as in the first optical communication system 10a of FIG. 1A.

While FIG. 7 shows the receiver module 50 as including a particular number and arrangement of components, in some embodiments, the receiver module 50 may include additional components, fewer components, different components, or differently arranged components. The number of detectors 330 and/or ADCs 340 may be selected to implement the receiver module 50 that is capable of receiving the optical signal. In some instances, one of the components illustrated in FIG. 7 may carry out a function described herein as being carry out by another one of the components illustrated in FIG. 7.

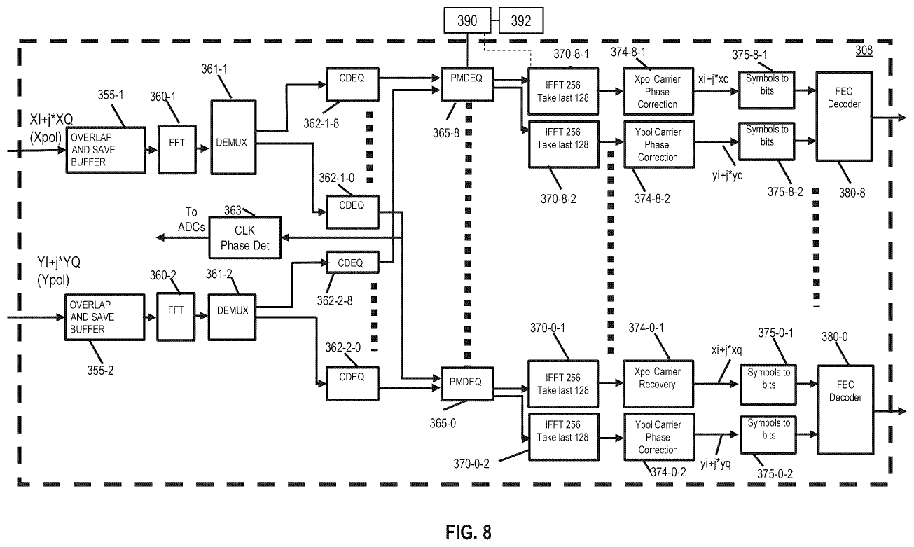

Referring now to FIG. 8, shown therein is a diagram of an exemplary embodiment of the receiver DSP 308 constructed in accordance with the present disclosure. As noted above, ADCs 340 (analog-to-digital (A/D) circuits) (FIG. 7) output digital samples corresponding to the analog inputs supplied thereto. In one example, the samples may be supplied by each ADC 340 at a rate of 64 GSamples/s. The digital samples correspond to symbols carried by the X polarization of the optical subcarriers and may be represented by the complex number XI+jXQ. The digital samples may be provided to a first overlap and save buffer 355-1, as shown in FIG. 8. A first FFT component 360-1 may receive 2048 vector elements, for example, from the first overlap and save buffer 355-1 and convert the vector elements to the frequency domain using, for example, a fast Fourier transform (FFT). The first FFT component 360-1 may convert the 2048 vector elements to 2048 frequency components, each of which may be stored in a register or “bin” or other memory, as a result of carrying out the FFT.

The frequency components then may be demultiplexed by a first demultiplexer 361-1, and groups of such components may be supplied to a respective one of first chromatic dispersion equalizer circuits 362-1, i.e., to first CDEQ circuits 362-1-0 to 362-1-8, each of which may include a finite impulse response (FIR) filter that corrects, offsets, or reduces the effects of, or errors associated with, chromatic dispersion of the transmitted optical subcarriers. Each of first CDEQ circuits 362-1-0 to 362-1-8 supplies an output to a corresponding first polarization mode dispersion (PMD) equalizer circuit 365-0 to 365-8 (which individually or collectively may be referred to as PMDEQ circuits 365).

Digital samples output from second ACDs 340-2 associated with Y polarization components of subcarrier SC1 may be processed in a similar manner to that of digital samples output from first ACDs 340-1 and associated with the X polarization component of each subcarrier. Namely, a second overlap and save buffer 355-2, a second FFT 360-2, a second demultiplexer 361-2, and second CDEQ circuits 362-2-0 to 362-2-8 may have a similar structure and operate in a similar fashion as the first overlap and save buffer 355-1, the first FFT 360-1, the first demultiplexer 361-1, and the first CDEQ circuits 362-1-0 to 362-1-8, respectively. For example, each of the second CDEQ circuits 362-2-0 to 362-8 may include an FIR filter that corrects, offsets, or reduces the effects of, or errors associated with, chromatic dispersion of the transmitted optical subcarriers. In addition, each of the second CDEQ circuits 362-2-0 to 362-2-8 provide an output to a corresponding one of PMDEQs 365-0 to 365-8.

As further shown in FIG. 8, the output of one of the CDEQ circuits 362, such as CDEQ 362-1-0 may be supplied to a clock phase detector circuit 363 to determine a clock phase or clock timing associated with the received subcarriers. Such phase or timing information or data may be supplied to the first and second ADCs 340-1 and 340-2 to adjust or control the timing of the digital samples output from the first and second ADCs 340-1 and 340-2.

In one embodiment, phase or timing information or data may be supplied to a particular ADC 340 to adjust or control the timing of a digital sample output from the particular ADC 340 corresponding to the pulse 204. In some embodiments, the phase, timing information, and/or data supplied to the particular ADC 340 may include, for example, the phase, timing information, and/or additional spectrum/tone data corresponding to the pulse 204 (which may be retrieved from the first memory 392a by the first DSP 390a). In this way, the pulse reflections 212 may have a timing and/or phase that is different from the pulse 204 (and that may be different from the subcarriers SC0-SC7) and may be analyzed independently of the subcarriers SC0-SC7.

Each of PMDEQ circuits 365 may include another FIR filter that corrects, offsets, or reduces the effects of, or errors associated with, PMD of the transmitted optical subcarriers. Each of PMDEQ circuits 365 may supply a first output to a respective one of first IFFT components or circuits 370-0-1 to 370-8-1 and a second output to a respective one of second IFFT components or circuits 370-0-2 to 370-8-2, each of which may convert a 256-element vector, in this example, back to the time domain as 256 samples in accordance with, for example, an inverse fast Fourier transform (IFFT).

Time domain signals or data output from the first IFFT 370-0-1 to 370-8-1 are supplied to a corresponding one of first Xpol carrier phase correction circuits 374-0-1 to 374-8-1, which may apply carrier recovery techniques to compensate for X polarization transmitter (e.g., optical source 120) and receiver (e.g., local oscillator laser 316) linewidths. In some embodiments, each first carrier phase correction circuit 374-0-1 to 374-8-1 may compensate or correct for frequency and/or phase differences between the X polarization of the transmit signal and the X polarization of light from the local oscillator laser 316 based on an output of Xpol carrier recovery circuit 374-0-1, which performs carrier recovery in connection with one of the subcarriers SC0-SC7 based on the outputs of the first IFFT 370-0-1. After such X polarization carrier phase correction, the data associated with the X polarization component may be represented as symbols having the complex representation xi+j*xq in a constellation, such as a QPSK constellation or a constellation associated with another modulation formation, such as an m-quadrature amplitude modulation (QAM), m being an integer. In some embodiments, the taps of the FIR filter included in one or more of the PMDEQ circuits 365 may be updated based on the output of at least one of carrier phase correction circuits 374-0-1 to 374-8-1.

In a similar manner, time domain signals or data output from second IFFT 370-0-2 to 370-8-2 are supplied to a corresponding one of Ypol carrier phase correction circuits 374-0-2 to 374-8-2, which may compensate or correct for Y polarization transmitter (e.g., optical source 120) and receiver (e.g., local oscillator laser 316) linewidths. In some embodiments, each Ypol carrier phase correction circuit 374-0-2 to 374-8-2 also may correct or compensate for frequency and/or phase differences between the Y polarization of the transmit signal and the Y polarization of light from the local oscillator laser 316. After such Y polarization carrier phase correction, the data associated with the Y polarization component may be represented as symbols having the complex representation yi+j*yq in a constellation, such as a QPSK constellation or a constellation associated with another modulation formation, such as an m-quadrature amplitude modulation (QAM), m being an integer. In some embodiments, the output of one of the Ypol carrier correction circuits 374-0-2 to 374-8-2 may be used to update the taps of the FIR filter included in one or more of the PMDEQ circuits 365 instead of, or in addition to, the output of at least one of the Xpol carrier recovery circuits 374-0-1 to 374-8-1.

As further shown in FIG. 8, the output of carrier recovery circuits, e.g., the Xpol carrier recovery circuit 374-0-1, also may be supplied to Xpol carrier phase correction circuits 374-1-1 to 374-8-1 and Ypol carrier phase correction circuits 374-0-2 to 374-8-2, whereby the carrier phase correction circuits 374 may determine or calculate a corrected carrier phase associated with each of the received subcarriers based on one of the recovered carriers, instead of providing multiple carrier recovery circuits, each of which is associated with a corresponding subcarrier. The equalizer, carrier recovery, and clock recovery may be further enhanced by utilizing the known (training) bits that may be included in control signals CNT, for example by providing an absolute phase reference between the transmitted and local oscillator lasers.

Each of a first symbols-to-bits circuits or components 375-0-1 to 375-8-1 may receive the symbols output from a corresponding one of the Xpol carrier phase correction circuits 374-0-1 to 374-8-1 and map the symbols back to bits. For example, each of the first symbol-to-bits components 375-0-1 to 375-8-1 may map one X polarization symbol, in a QPSK or m-QAM constellation, to Z bits, where Z is an integer. For dual-polarization QPSK modulated subcarriers, Z is four. Bits output from each of the first symbol-to-bits components 375-0-1 to 375-8-1 are provided to a corresponding one of FEC decoder circuits 380-0 to 380-8.

Y polarization symbols are output form a respective one of Ypol carrier phase correction circuits 374-0-2 to 374-8-2, each of which has the complex representation yi+j*yq associated with data carried by the Y polarization component. Each Y polarization, like the X polarization symbols noted above, may be provided to a corresponding one of second symbol-to-bit circuits or components 375-0-2 to 375-8-2, each of which has a similar structure and operates in a similar manner as first symbols-to-bits component 375-0-1 to 375-8-1. Each of the second symbol-to-bits circuits 375-0-2 to 375-8-2 may provide an output to a corresponding one of the FEC decoder circuits 380-0 to 380-8.

In another example, data associated with a subcarrier SC received, but not intended for output from that receiver, can be blocked by inserting zeroes (0s) in chromatic dispersion equalizer (CDEQ) circuits 362 associated with both the X and Y polarization components of each subcarrier. In particular, multiplier circuits (provided in corresponding butterfly filter circuits), like multiplier circuits M described above, may selectively multiply the inputs to the particular CDEQ circuit 362 by either zero or a desired coefficient. As multiplication by a zero generates a zero product, such zero products are further processed by corresponding circuitry in receiver DSP 308, e.g., corresponding IFFTs 370, carrier phase correction circuits 374, symbol-to-bits components 375, and FEC decoders 380, a corresponding output of the receiver DSP 308 will also be zero. In one embodiment, a subcarrier SC adjacent to the RF modulated tone 180 may be blocked. For example, if the RF modulated tone 180 is provided adjacent the first optical subcarrier SC0, then the first optical subcarrier SC0, adjacent to the RF modulated tone 180, may be blocked. Because the first optical subcarrier SC0 is blocked, or “turned off”, any data associated with the first optical subcarrier SC0 received may be blocked as described above.

While FIG. 8 shows the receiver DSP 308 as including a particular number and arrangement of functional components, in some embodiments, the receiver DSP 308 may include additional functional components, fewer functional components, different functional components, or differently arranged functional components.

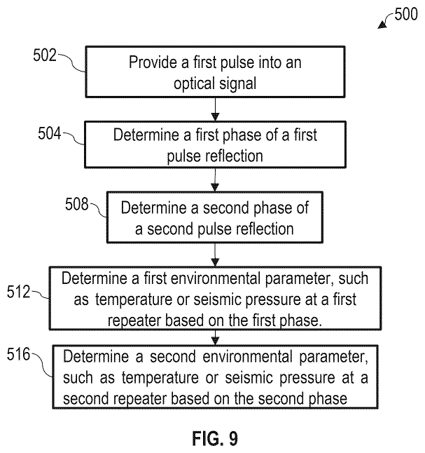

Referring now to FIG. 9, shown therein is a flowchart of an exemplary embodiment of a detection process 500 that may be carried out in accordance with the present disclosure. In the exemplary embodiment, the detection process 500 detection generally determines an environmental parameter, such as temperature and/or a seismic pressure across a fiber optic span 24 within the optical fiber submarine cable 20. The detection process 500 generally comprises the steps of: providing a first pulse into an optical signal (step 502); determining a first RF phase for a first pulse reflection (step 504); determining a second RF phase for the second pulse reflection (step 508); determining a first environmental parameter, such as first temperature and/or first seismic pressure at a first optical repeater based on the first RF phase (step 512); and determining a second environmental parameter, such as a second temperature and/or second seismic pressure at a second optical repeater based on the second RF phase (step 516). The environmental parameter can be determined with the use of a database of measured RF phases and measured environmental parameters. Thus, when the RF phase is measured, the RF phase can be correlated with a particular environmental parameter to determine the environmental parameter for the measured RF phase.

In one embodiment, providing a first pulse into an optical signal (step 502) includes providing the first pulse 204 into the optical signal transmitted in the fiber optic span 24 from the primary node 14 towards the secondary node 30. The fiber optic span 24 may be, for example, a portion of the optical fiber submarine cable 20.

In one embodiment, providing the first pulse into the optical signal (step 502) may include providing the first pulse having the RF modulated tone 180. The RF modulated tone 180 may have an RF amplitude modulation in a range of about 10 MHz to 100 MHz, for example, 90 MHz.

In one embodiment, determining a first RF phase for a first pulse reflection (step 504) may include measuring an optical power of the first pulse reflection 212-1, e.g., with the phase detector 60 in communication with the DSP 390, as described above in more detail. In one embodiment, determining the first RF phase for the first pulse reflection (step 504) includes first determining a local RF phase for the local pulse reflection 212-0, e.g., with the phase detector 60 in communication with the DSP 390. In one embodiment, determining the first RF phase for the first pulse reflection (step 504) may include measuring the optical power of the first pulse reflection 212-1 using the photodetectors of the receiver module 50.

In one embodiment, determining a second RF phase for the second pulse reflection (step 508) may include measuring an optical power of the second pulse reflection 212-2, e.g., with the phase detector 60 in communication with the DSP 390, as described above in more detail. In one embodiment, determining the second RF phase for the second pulse reflection (step 508) may include measuring the optical power of the second pulse reflection 212-2 using the photodetectors of the receiver module 50.

In one embodiment, determining the first temperature and/or first seismic pressure at the first optical repeater based on the first RF phase (step 512) may include the DSP 390 using known tide data, such as tide heights at particular points in time throughout the day, to correlate particular RF phases to a particular temperature and/or particular seismic pressure. The DSP 390 may then compare the first RF phase to the particular RF phases to determine the first temperature and/or the first seismic pressure.

In one embodiment, determining the first temperature and/or first seismic pressure at the first optical repeater based on the first RF phase (step 512) may include the DSP 390 using known tide data to generate an expected variation in the RF phase at the first optical repeater based on known tide heights at particular times of day, and comparing an RF phase difference between the local RF phase and the first RF phase to the expected variation in the RF phase to get an environmental phase change (e.g., a change in RF phase attributable to the environmental disturbance 210). The DSP 390 may then analyze the environmental phase change to determine the first temperature and/or the first seismic pressure at the first optical repeater due to the environmental disturbance 210.

In one embodiment, determining the first temperature and/or first seismic pressure at the first optical repeater based on the first RF phase (step 512) may include the DSP 390 storing RF phase data for each fiber optic span over a period of time to determine a first RF phase change baseline for each fiber optical span. The DSP 390 may compare the first RF phase to the first RF phase change baseline to determine a baseline difference indicative of a change in temperature and/or seismic pressure from baseline conditions. The DSP 390 may then correlate this baseline difference to a first temperature change and/or a first seismic pressure change from a known temperature and/or seismic pressure to determine the first temperature and/or first seismic pressure.

In one embodiment, determining the second temperature and/or second seismic pressure at the second optical repeater based on the second RF phase (step 516) may include the DSP 390 using known tide data, such as tide heights at particular points in time throughout the day, to correlate particular RF phases to a particular temperature and/or particular seismic pressure. The DSP 390 may then compare the second RF phase to the particular RF phases to determine the second temperature and/or the second seismic pressure at the second optical repeater.

In one embodiment, determining the second temperature and/or second seismic pressure at the second optical repeater based on the second RF phase (step 516) may include the DSP 390 using known tide data to generate an expected variation in the RF phase at the second optical repeater based on known tide heights at particular times of day, and comparing an RF phase difference between the local (or first) RF phase and the second RF phase to the expected variation in the RF phase to get an environmental phase change. The DSP 390 may then analyze the environmental phase change to determine the second temperature and/or the second seismic pressure at the second optical repeater due to the environmental disturbance 210.

In one embodiment, the DSP 390 may further identify the location 270 of the environmental disturbance(s) 210 by triangulating the location 270 of the environmental disturbance(s) 210 based on two or more of: a local timestamp of the local tone reflection having the local RF phase, a first timestamp of the first tone reflection having the first RF phase and the first temperature and/or first seismic pressure, a second timestamp of the second tone reflection having the second RF phase and the second temperature and/or second seismic pressure, and a location of each of the primary node 14, the first optical repeater, and the second optical repeater.

From the above description and examples, it is clear that the inventive concepts disclosed and claimed herein are well adapted to attain the advantages mentioned herein. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

Various modifications and other embodiments will be apparent to those skilled in the art from consideration of the present specification, and the detailed embodiments described above are provided as examples. For example, the digital signal process disclosed above may be implemented as a programmable gate array circuit (PGA), or a field programmable gate array circuit (FPGA). In addition, although separate ones of the optical source 120 and the local oscillator laser 316 are provided in the transmitter module 46 and receiver module 50, respectively, as noted above, a transceiver module 18 consistent with the present disclosure may include a common laser (or optical source) that is “shared” between the transmitter and receiver.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set. Accordingly, other embodiments are within the scope of the claims.

What is claimed is:

1. A node, comprising:
an optical source configured to provide an optical signal into a fiber optic cable having at least two optical repeaters forming a first fiber optic span and a second fiber optic span;
a modulator receiving the optical signal, the modulator configured to encode data into the optical signal;
a transmitter module having circuitry configured to receive data to be encoded into the optical signal, the circuitry including at least one driver circuit supplying drive signals to the modulator to cause the modulator to encode data, and the circuitry configured to cause the modulator to generate a plurality of pulses having a radio frequency modulated tone, into the optical signal;
a receiver module operable to receive reflections of the optical signal from optical repeaters in the fiber optic cable, the optical signal having the radio frequency modulated tone; and
a digital signal processor operable to:
determine a first RF phase of a first pulse reflection corresponding to a first pulse of the plurality of pulses at a first instance of time, the first RF phase being determined using the radio frequency modulated tone of the first pulse reflection;
determine a second RF phase of a second pulse reflection corresponding to the first pulse and received at a second instance of time after the first instance of time, the second RF phase being determined using the radio frequency modulated tone of the second pulse reflection; and
determine a first seismic pressure within the first fiber optic span based on the first RF phase and a second seismic pressure within the second fiber optic span based on the second RF phase.

2. The node of claim 1, further comprising:
a narrowband filter operable to receive reflections of the optical signal and filter each pulse reflection from the reflection of the optical signal; and
a phase detector operable to receive each filtered pulse reflection from the narrowband filter and to measure the first RF phase of the first pulse reflection and the second RF phase of the second pulse reflection; and
wherein the digital signal processor is in communication with the phase detector to determine the first RF phase and the second RF phase.

3. The node of claim 2, wherein the phase detector comprises:
a photodetector configured to receive each filtered pulse reflection and to generate a power signal indicative of an optical power of the pulse reflection; and
a digital-to-analog converter configured to receive the power signal and generate a stream of optical power measurement data.

4. The node of claim 2, wherein the narrowband filter has a bandwidth of about 1.5 GHZ.

5. The node of claim 1, wherein the circuitry is configured to cause the modulator to generate the pulse having the radio frequency modulated tone, the radio frequency modulated tone being an amplitude modulation of an RF signal applied to the optical signal.

6. The node of claim 1, wherein the optical repeaters further include a high loss loopback having a fiber Bragg grating with a tuned frequency, and wherein the circuitry is further configured to cause the modulator to generate the pulse having the radio frequency modulated tone, into the optical signal at the tuned frequency.

7. The node of claim 1, wherein the digital signal processor is further operable to:
determine a third RF phase of a first pulse reflection corresponding to a second pulse of the plurality of pulses at a third instance of time, the third RF phase being determined using the radio frequency modulated tone of the first pulse reflection corresponding to the second pulse;
determine a fourth RF phase of a second pulse reflection corresponding to the second pulse and received at a fourth instance of time after the third instance of time, the fourth RF phase being determined using the radio frequency modulated tone of the second pulse reflection corresponding to the second pulse; and
determine a third seismic pressure within the first fiber optic span based on the third RF phase corresponding to the second pulse and a fourth seismic pressure within the second fiber optic span based on the fourth RF phase corresponding to the second pulse.

8. The node of claim 7, wherein the digital signal processor is further operable to:
determine a first change in seismic pressure within the first fiber optic span based on the first seismic pressure and the third seismic pressure; and
determine a second change in seismic pressure within the second fiber optic span based on the second seismic pressure and the fourth seismic pressure.

9. The node of claim 8, wherein the digital signal processor is further operable to:
identify an environmental disturbance based on at least one of the first change in seismic pressure within the first fiber optic span and the second change in seismic pressure within the second fiber optic span.

10. The node of claim 9, wherein the digital signal processor is further operable to:
identify a disturbance location of the environmental disturbance based on at least one of the first change in seismic pressure within the first fiber optic span and the second change in seismic pressure within the second fiber optic span.

11. The node of claim 1, wherein the plurality of pulses exhibits a duty cycle between successive pulses.

12. The node of claim 11, wherein the duty cycle is about 100 ms.

13. The node of claim 1, wherein each pulse of the plurality of pulses has a pulse width no greater than the lesser of a first propagation duration of the optical signal within the first fiber optic span and a second propagation duration of the optical signal within the second fiber optic span.

14. The node of claim 13, wherein the pulse width is about 200 microseconds.

15. A subsea optical communication system, comprising:
a fiber optic cable;
an optical repeater coupled to the fiber optic cable, the optical repeater comprising a high loss loopback having a fiber Bragg grating having a tuned frequency, the high loss loopback being operable to generate a pulse reflection at the tuned frequency; and
a primary node coupled to the fiber optic cable, the fiber optic cable between the optical repeater and the primary node forming a first span, the primary node comprising:
an optical source configured to provide an optical signal;
a modulator receiving the optical signal from the optical source, the modulator configured to encode data into the optical signal;
a transmitter module having circuitry configured to receive data to be encoded into the optical signal, the circuitry including at least one driver circuit supplying drive signals to the modulator to cause the modulator to encode data, and the circuitry configured to cause the modulator to generate a plurality of pulses having a radio frequency modulated tone, into the optical signal;
a receiver module operable to receive reflections of the optical signal, the reflections of the optical signal having pulse reflections with the radio frequency modulated tone;
an optical loopback configured to generate a local reflection of the optical signal from the transmitter module, the local reflection having the radio frequency modulated tone, and direct the local reflection towards the receiver module as a local pulse reflection; and
a digital signal processor operable to:
determine a first RF phase of the local pulse reflection corresponding to a first pulse at a first instance of time, the first RF phase being determined using the radio frequency modulated tone of the local pulse reflection;
determine a second RF phase of the pulse reflection corresponding to the first pulse and received at a second instance of time after the first instance of time, the second RF phase being determined using the radio frequency modulated tone of the pulse reflection; and
determine an environmental parameter within the first fiber optic span based on a first difference between the first RF phase and the second RF phase.

16. The subsea optical communication system of claim 15, wherein the primary node further comprises:
a narrowband filter operable to receive reflections of the optical signal and filter each pulse reflection from the reflection of the optical signal; and
a phase detector operable to receive each filtered pulse reflection from the narrowband filter and to measure the first RF phase of the local pulse reflection and the second RF phase of the pulse reflection; and
wherein the digital signal processor is in communication with the phase detector to determine the first RF phase and the second RF phase.

17. The subsea optical communication system of claim 16, wherein the phase detector comprises:
a photodetector configured to receive each filtered pulse reflection and to generate a power signal indicative of an optical power of the respective pulse reflection; and
a digital-to-analog converter configured to receive the power signal and generate a stream of optical power measurement data.

18. The subsea optical communication system of claim 17, wherein the circuitry is further configured to cause the modulator to generate the pulse having the radio frequency modulated tone, into the optical signal, at the tuned frequency.

19. The subsea optical communication system of claim 15, wherein the digital signal processor is further operable to:
determine a third RF phase of the local pulse reflection corresponding to a second pulse at a third instance of time, the third RF phase being determined using the radio frequency modulated tone of the local pulse reflection;
determine a fourth RF phase of the pulse reflection corresponding to the second pulse and received at a fourth instance of time after the third instance of time, the fourth RF phase being determined using the radio frequency modulated tone of the pulse reflection; and
determine a second seismic pressure within the first fiber optic span based on a second difference between the third RF phase and the fourth RF phase.

20. The subsea optical communication system of claim 19, wherein the digital signal processor is further operable to:
determine a change in the environmental parameter within the first fiber optic span based on the first seismic pressure and the third seismic pressure; and
identify at least one of an environmental disturbance and a disturbance location based on one or more of: the first difference, the second difference, and the change in seismic pressure within the first fiber optic span.
